(19) United States
(12) Patent Application Publication
(10) Pub. No.: US 2017/0261435 A1
(43) Pub. Date: Sep. 14, 2017

(54) SURFACE-ENHANCED RAMAN SCATTERING UNIT

(71) Applicant: HAMAMATSU PHOTONICS K.K., Hamamatsu-shi, Shizuoka (JP)

(72) Inventors: Hiroki OYAMA, Hamamatsu-shi (JP); Katsumi SHIBAYAMA, Hamamatsu-shi (JP); Masashi ITO, Hamamatsu-shi (JP); Kazuto OFUJI, Hamamatsu-shi (JP); Yoshihiro MARUYAMA, Hamamatsu-shi (JP)

(73) Assignee: HAMAMATSU PHOTONICS K.K., Hamamatsu-shi, Shizuoka (JP)

(21) Appl. No.: 15/509,549

(22) PCT Filed: Sep. 8, 2015
(86) PCT No.: PCT/JP2015/075420

§ 371 Date: Mar. 8, 2017

(30) Foreign Application Priority Data
Sep. 10, 2014 (JP) 2014-184266

(51) Int. Cl. G01N 21/65

(52) U.S. Cl. CPC G01N 21/658

(57) ABSTRACT

A surface-enhanced Raman scattering unit includes a surface-enhanced Raman scattering element including an optical functional portion that causes surface-enhanced Raman scattering, and a support member that supports the surface-enhanced Raman scattering element. The surface-enhanced Raman scattering element is fixed to the support member due to a magnetic force.

### TECHNICAL FIELD

An aspect of the present invention relates to a surface-enhanced Raman scattering unit.

### BACKGROUND ART

As a surface-enhanced Raman scattering unit of the related art, a surface-enhanced Raman scattering unit in which a surface-enhanced Raman scattering element having an optical functional portion causing surface-enhanced Raman scattering (SERS) is fixed on a slide glass is known (see, for example, Non-Patent Literature 1).

### CITATION LIST

### Non Patent Literature

Non-patent document 1: “Q-SERS™ G1 Substrate”, [online], Optoscience Co., Ltd. [Searched on Jun. 6, 2014], Internet <URL: http://www.optoscience.com/maker/nanova/pdf/Q-SERS_G1.pdf>

### SUMMARY OF INVENTION

### Technical Problem

In a surface-enhanced Raman scattering unit as described above, since a surface-enhanced Raman scattering element is fixed on a slide glass with an adhesive, an optical functional portion may deteriorate due to components contained in the adhesive. Meanwhile, a form in which a surface-enhanced Raman scattering element is mechanically fixed to a slide glass using a holding member fitted to the slide glass is also assumed. In this case, the optical functional portion may deteriorate due to physical interference between the holding member and the optical functional portion.

An aspect of the present invention is to provide a surface-enhanced Raman scattering unit capable of suppressing deterioration of an optical functional portion.

### Solution to Problem

A surface-enhanced Raman scattering unit according to an aspect of the present invention includes a surface-enhanced Raman scattering element including an optical functional portion that causes surface-enhanced Raman scattering; and a support member that supports the surface-enhanced Raman scattering element, wherein the surface-enhanced Raman scattering element is fixed to the support member due to a magnetic force.

In this surface-enhanced Raman scattering unit, the surface-enhanced Raman scattering element including the optical functional portion is fixed to the support member due to a magnetic force. Therefore, deterioration of the optical functional portion due to components contained in an adhesive, for example, as in the case in which the surface-enhanced Raman scattering element is fixed to the support member with the adhesive, can be prevented. Further, deterioration of the optical functional portion due to physical interference between a holding member and an optical functional portion, for example, as in the case in which the surface-enhanced Raman scattering element is mechanically fixed to the support member by a holding member, can be prevented. Thus, according to this surface-enhanced Raman scattering unit, it is possible to suppress deterioration of the optical functional portion.

In the surface-enhanced Raman scattering unit according to an aspect of the present invention, the magnetic force may be an attractive force. In this case, it is possible to simplify a structure for fixing the surface-enhanced Raman scattering element to the support member.

In the surface enhanced Raman scattering unit according to an aspect of the present invention, the surface-enhanced Raman scattering element may be arranged in a recessed portion provided in the support member. In this case, the surface-enhanced Raman scattering element can be positioned by an inner wall of the recessed portion. Further, when the recessed portion is deep and the entire surface-enhanced Raman scattering element is arranged in the recessed portion, the optical functional portion is protected from contact or contamination according to the contact. Further, in this case, the recessed portion can be used as a cell (chamber) for a solution sample or the like.

The surface-enhanced Raman scattering unit according to an aspect of the present invention may include a first magnet portion and a second magnet portion that generate the magnetic force therebetween, wherein the first magnet portion may be provided in the surface-enhanced Raman scattering element, and the surface-enhanced Raman scattering element may be fixed to the support member by the magnetic force in a state in which the surface-enhanced Raman scattering element is spaced apart from the second magnet portion. In this case, a degree of freedom of molding of the support member is higher than in a case in which the surface-enhanced Raman scattering element is fixed to the support member while being in contact with the second magnet portion.

Here, the first and second magnet portions generate a magnetic force therebetween. Therefore, both of the first and second magnet portions may be configured with a permanent magnet or one of the first and second magnet portions may be configured with a permanent magnet and the other may be configured with a temporary magnet. Further, it is not assumed that both of the first and second magnet portions are configured with a temporary magnet.

Here, the permanent magnet is made of a substance that holds a property of a magnet for a long period of time without being supplied with a magnetic field or a current from the outside. Further, here, the temporary magnet is made of a substance having a property of a magnet only while being magnetized from the outside.

In the surface-enhanced Raman scattering unit according to an aspect of the present invention, the support member may include a first surface and a second surface opposite to the first surface, the surface-enhanced Raman scattering element may be arranged on the first surface, the second magnet portion may be arranged on the second surface, and the surface-enhanced Raman scattering element may be movable along the first surface according to movement of the second magnet portion along the second surface. In this case, it is possible to easily arrange the surface-enhanced Raman scattering element at a desired position by moving the second magnet portion and moving the surface-enhanced Raman scattering element.

The surface-enhanced Raman scattering unit according to an aspect of the present invention includes a first magnet portion and a second magnet portion that generate the magnetic force therebetween, wherein the first magnet portion is provided in the surface-enhanced Raman scattering element, and the surface-enhanced Raman scattering element may be fixed to the support member by the magnetic force in a state in which the surface-enhanced Raman scattering element is brought into contact with the second magnet portion. In this case, since the first magnet portion and the second magnet portion are close to each other in comparison with a case in which the surface-enhanced Raman scattering element is fixed to the support member while being spaced apart from the second magnet portion, fixation strength is high. Further, it is possible to achieve compactness of the entirety.

The surface-enhanced Raman scattering unit according to an aspect of the present invention may include a first magnet portion and a second magnet portion that generate the magnetic force therebetween, wherein the surface-enhanced Raman scattering element may be fixed to the support member by the magnetic force in a state in which the surface-enhanced Raman scattering element is sandwiched between the first magnet portion and the second magnet portion. In this case, since it is not necessary for the first magnet portion to be provided in the surface-enhanced Raman scattering element, the manufacture of the surface-enhanced Raman scattering element is facilitated.

In the surface-enhanced Raman scattering unit according to an aspect of the present invention, the support member may be configured as a second magnet portion. In this case, it is possible to realize convenience of member management or cost reduction by reducing the number of members.

In the surface-enhanced Raman scattering unit according to an aspect of the present invention, the surface-enhanced Raman scattering element may include a substrate including a main surface and a back surface opposite to the main surface, a fine structure portion provided on the main surface, and a conductor layer provided on the fine structure portion, and the first magnet portion may be provided at least one of: on the back surface, between the main surface and the fine structure portion, between the fine structure portion and the conductor layer, and on a side surface of the surface-enhanced Raman scattering element extending in a direction intersecting the main surface. In a case in which the first magnet portion is provided on the back surface of the substrate among the cases, since the first magnet portion and the second magnet portion can be caused to be close to each other (brought into contact with each other) on the back surface side of the substrate, fixation strength can be improved. Further, in a case in which the first magnet portion is provided between the main surface of the substrate and the fine structure portion and between the fine structure portion and the conductor layer, the first magnet portion can be used as a reflective portion of excitation light. Further, in a case in which the first magnet portion is provided between the fine structure portion and the conductor layer, since the first magnet portion and the second magnet portion can be caused to be close to each other on the main surface side (optical functional portion side) of the substrate, fixation strength can be improved.

In the surface-enhanced Raman scattering unit according to an aspect of the present invention, the surface-enhanced Raman scattering element may include a substrate including a main surface and a back surface opposite to the main surface, a fine structure portion provided on the main surface, and a conductor layer provided on the fine structure portion and constituting the optical functional portion, and at least one of the substrate, the fine structure portion, or the conductor layer may be formed as the first magnet portion. In a case in which the substrate is configured as the first magnet portion among the cases, since the first magnet portion and the second magnet portion can be caused to be close to each other (or are brought into contact with each other) on the back surface side of the substrate, fixation strength can be improved. Further, in a case in which the fine structure portion is configured as the first magnet portion, the fine structure portion can be efficiently used as a reflective portion of excitation light. Further, in a case in which the conductor layer is configured as the first magnet portion, since the first magnet portion and the second magnet portion can be caused to be close to each other (or are brought into contact with each other) on the main surface side (optical functional portion side) of the substrate, fixation strength can be improved.

### Advantageous Effects of Invention

According to an aspect of the present invention, it is possible to provide the surface-enhanced Raman scattering unit capable of suppressing deterioration of the optical functional portion.

### BRIEF DESCRIPTION OF DRAWINGS

FIG. 1 is a plan view of a surface-enhanced Raman scattering unit according to a first embodiment.

FIG. 2 is a cross-sectional view taken along line II-II of FIG. 1.

FIG. 3 is a partial cross-sectional view of the surface-enhanced Raman scattering unit illustrated in FIG. 2.

FIG. 4 is an SEM photograph of an optical functional portion illustrated in FIG. 2.

FIG. 5 is a configuration diagram of a Raman spectroscopic analysis device in which the surface-enhanced Raman scattering unit illustrated in FIG. 2 is set.

FIG. 6 is a cross-sectional view illustrating a modification example of the surface-enhanced Raman scattering unit illustrated in FIG. 2.

FIG. 7 is a cross-sectional view illustrating a modification example of the surface-enhanced Raman scattering unit illustrated in FIG. 2.

FIG. 8 is a schematic cross-sectional view illustrating a modification example of the surface-enhanced Raman scattering unit illustrated in FIG. 2.

FIG. 9 is a schematic cross-sectional view illustrating the modification example of the surface-enhanced Raman scattering unit illustrated in FIG. 2.

FIG. 10 is a schematic view illustrating a modification example of the surface-enhanced Raman scattering unit illustrated in FIG. 2.

FIG. 11 is a schematic cross-sectional view illustrating the modification example of the surface-enhanced Raman scattering unit illustrated in FIG. 2.

FIG. 12 is a partial perspective view illustrating the modification example of the surface-enhanced Raman scattering unit illustrated in FIG. 2.

FIG. 13 is a cross-sectional view of a surface-enhanced Raman scattering unit according to a second embodiment.

FIG. 14 is a schematic cross-sectional view illustrating a modification example of the surface-enhanced Raman scattering unit illustrated in FIG. 13.

FIG. 15 is a schematic cross-sectional view illustrating a modification example of the surface-enhanced Raman scattering unit illustrated in FIG. 13.

FIG. 16 is a cross-sectional view of a surface-enhanced Raman scattering unit according to a third embodiment.

FIG. 17 is a schematic cross-sectional view illustrating a modification example of the surface-enhanced Raman scattering unit illustrated in FIG. 16.

FIG. 18 is a schematic cross-sectional view illustrating a modification example of the surface-enhanced Raman scattering element illustrated in FIG. 2.

FIG. 19 is a schematic cross-sectional view illustrating a modification example of the surface-enhanced Raman scattering element illustrated in FIG. 2.

FIG. 20 is a schematic cross-sectional view illustrating a modification example of the surface-enhanced Raman scattering element illustrated in FIG. 2.

### DESCRIPTION OF EMBODIMENTS

Hereinafter, an embodiment of a surface-enhanced Raman scattering unit according to an aspect of the present invention will be described in detail with reference to the drawings. In description of the drawings, the same elements or corresponding elements are denoted with the same reference numerals, and repeated description may be omitted.

### First Embodiment

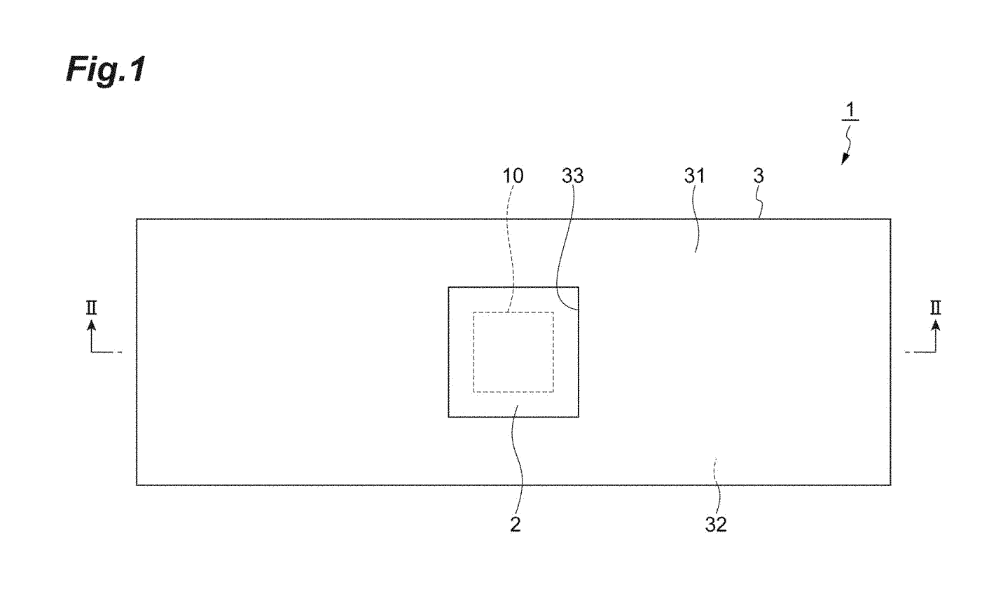

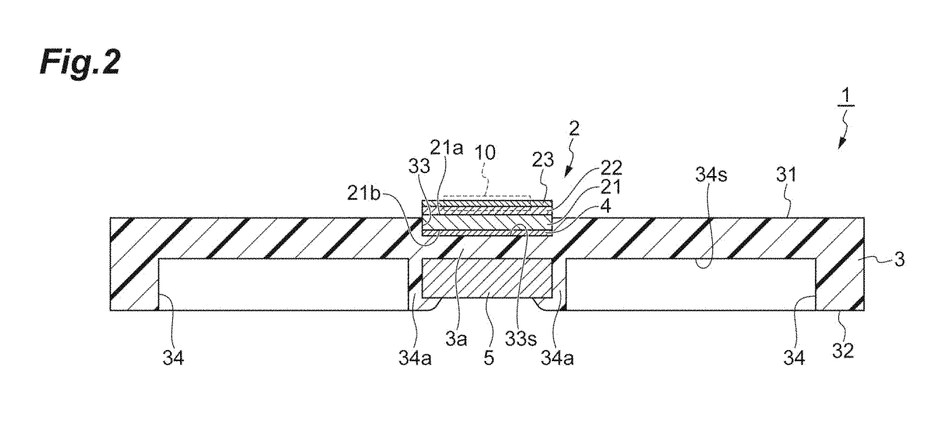

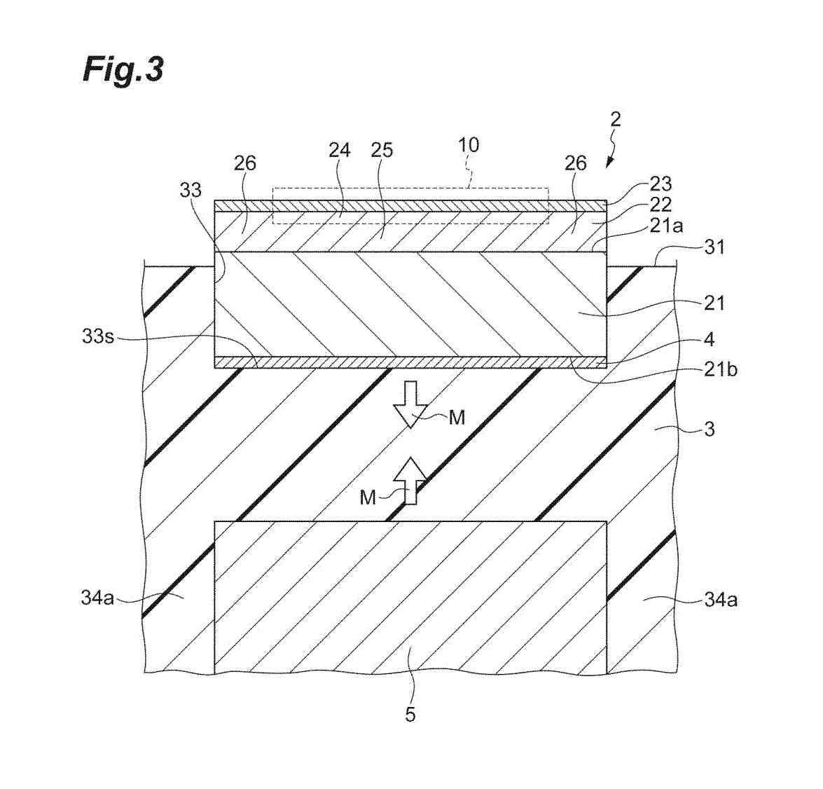

FIG. 1 is a plan view of a surface-enhanced Raman scattering unit according to a first embodiment. FIG. 2 is a cross-sectional view taken along line II-II of FIG. 1. FIG. 3 is a partial cross-sectional view of a surface-enhanced Raman scattering unit illustrated in FIG. 2. As illustrated in FIGS. 1 to 3, a surface-enhanced Raman scattering unit (SERS unit) 1 according to this embodiment includes a surface-enhanced Raman scattering element (SERS element) 2, a handling plate (support member) 3, a first magnet portion 4, and a second magnet portion 5. The SERS element 2 includes an optical functional portion 10 which causes surface-enhanced Raman scattering. The handling plate 3 supports the SERS element 2. The SERS element 2 is fixed to the handling plate 3 by magnetic force.

The handling plate 3 includes a main surface 31 and a back surface 32 opposite to the main surface 31. The handling plate 3 has a rectangular plate shape. A recessed portion 33 is formed in the main surface 31. The recessed portion 33 is arranged substantially at a center in a longitudinal direction and a lateral direction of the handling plate 3. The recessed portion 33 is formed in a rectangular parallelepiped shape. A recessed portion 34 is formed in the back surface 32. The recessed portion 34 is a concave portion in the handling plate 3.

A bottom surface (first surface) 33s of the recessed portion 33 and a bottom surface (second surface) 34s of the recessed portion 34 overlap each other when viewed from a thickness direction (a direction intersecting the main surface 31) of the handling plate 3. The bottom surface 33s and the bottom surface 34s extend substantially in parallel in a state in which the bottom surface 33s and the bottom surface 34s are spaced apart from each other. Therefore, a portion 3a of the handling plate 3 is interposed between the bottom surface 33s and the bottom surface 34s. The handling plate 3 is integrally formed of a material such as a resin (polypropylene, styrene resin, ABS resin, polyethylene, PET, PMMA, silicone, liquid crystal polymer, or the like), ceramic, glass, or silicon using a scheme such as molding, cutting, or etching.

The SERS element 2 includes a substrate 21, a molded layer 22, and a conductor layer 23. The substrate 21 includes a main surface 21a and a back surface 21b opposite to the main surface 21a. The substrate 21 is formed in a rectangular plate shape, for example, of silicon, glass, or the like. The substrate 21 has, for example, an appearance of hundreds of μm×hundreds of μm to tens of mm×tens of mm, and a thickness of about 100 μm to 2 mm.

The molded layer 22 is formed on the main surface 21a of the substrate 21. The molded layer 22 includes a fine structure portion 24, a support portion 25, and a frame portion 26. That is, the SERS element 2 includes the fine structure portion 24 provided on the main surface 21a of the substrate 21. The fine structure portion 24 is formed on a surface layer on the side opposite to the substrate 21 at a central portion of the molded layer 22. The fine structure portion 24 is formed on the main surface 21a of the substrate 21 via the support portion 25, for example. However, the fine structure portion 24 may be directly formed on the main surface 21a of the substrate 21.

The fine structure portion 24 has a rectangular appearance of, for example, hundreds of μm×hundreds of μm to tens of mm×tens of mm as a whole. The fine structure portion 24 is an area having a periodic pattern. More specifically, for example, a plurality of pillars having a thickness and a height of several nm to hundreds of nm as a periodic pattern are arranged periodically at a pitch of tens of nm to hundreds of nm along the main surface 21a of the substrate 21, for example, in the fine structure portion 24.

The support portion 25 is an area that supports the fine structure portion 24. The support portion 25 is formed on the main surface 21a of the substrate 21. The support portion 25 has, for example, a rectangular plate shape. The frame portion 26 is an area that surrounds the support portion 25. Therefore, the frame portion 26 has, for example, a rectangular annular shape. The frame portion 26 is formed on the main surface 21a of the substrate 21. The fine structure portion 24 may be formed not only on the support portion 25 but also over the frame portion 26 from the support portion 25. That is, the frame portion 26 may be formed with the same thickness as that of the support portion 25, and may be configured as a support portion that supports the fine structure portion 24. The support portion 25 and the frame portion 26 have a thickness of, for example, about tens of nm to tens of μm.

Such a molded layer 22 can be integrally formed by molding, for example, a resin (acrylic, fluorine, epoxy, silicone, urethane, PET, polycarbonate, inorganic organic hybrid material, or the like) or a low melting point glass arranged on the main surface 21a of the substrate 21 using a nanoimprinting method.

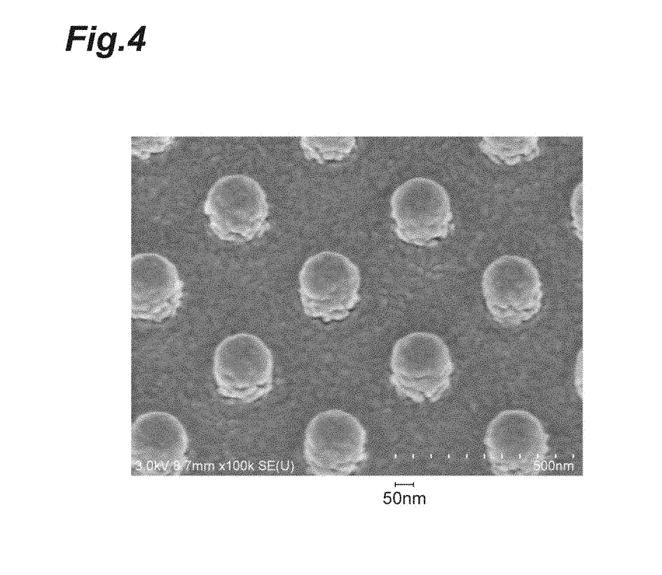

The conductor layer 23 is integrally formed on the fine structure portion 24 and on the frame portion 26. In the fine structure portion 24, the conductor layer 23 reaches a surface of the support portion 25 that is exposed at the opposite side of the substrate 21. In the SERS element 2, the optical functional portion 10 causing surface-enhanced Raman scattering is configured with a conductor layer 23 formed on a surface of the fine structure portion 24 and the surface of the support portion 25 exposed at the opposite side of the substrate 21 (See FIG. 4). For example, the conductor layer 23 has a thickness of about several nm to several μm. Such a conductor layer 23 can be formed, for example, by forming, through vapor deposition, a conductor such as a metal (Au, Ag, Al, Cu, Pt, or the like) on the molded layer 22 formed using a nanoimprinting method.

Here, the first magnet portion 4 is provided on the back surface 21b of the substrate 21. That is, the first magnet portion 4 is provided in the SERS element 2 (included in the SERS element 2). The first magnet portion 4 is formed in a film shape so as to constitute a bottom portion of the SERS element 2. Here, the first magnet portion 4 is formed over the entire back surface 21b. A material, a property, or the like of the first magnet portion 4 will be described below. The first magnet portion 4 can be formed, for example, by depositing various materials described below on the back surface 21b of the substrate 21.

The SERS element 2 is arranged in the recessed portion 33 of the handling plate 3. Here, a portion of the SERS element 2 (for example, a portion of the substrate 21) is accommodated in the recessed portion 33 in a thickness direction of the handling plate 3, and the other portion of the SERS element 2 projects from the recessed portion 33. Further, the SERS element 2 is arranged so that the back surface 21b of the substrate 21 is on the bottom surface 33s side of the recessed portion 33. For example, the SERS element 2 is arranged on the bottom surface 33s so that the first magnet portion 4 contacts the bottom surface 33s of the recessed portion 33.

Meanwhile, the second magnet portion 5 is arranged in the recessed portion 34 of the handling plate 3. More specifically, a locking projection 34a projects from the bottom surface 34s of the recessed portion 34. The second magnet portion 5 has, for example, a rectangular parallelepiped plate shape, is fitted (locked) to the locking projection 34a, and is held (arranged) on the bottom surface 34s. Therefore, the second magnet portion 5 and the SERS element 2 are close to each other and face each other in a state in which the portion 3a of the handling plate 3 is interposed between the second magnet portion 5 and the SERS element 2.

The first magnet portion 4 and the second magnet portion 5 generate a magnetic force M therebetween. Here, a magnetic force M generated between the first magnet portion 4 and the second magnet portion 5 is an attractive force. Therefore, in the SERS unit 1, the first magnet portion 4 and the second magnet portion 5 attract each other via the portion 3a of the handling plate 3 such that the SERS element 2 is pressed against the bottom surface 33s of the recessed portion 33 of the handling plate 3 and fixed to the handling plate 3.

Similarly, the second magnet portion 5 is also pressed against the bottom surface 34s of the recessed portion 34 of the handling plate 3. Therefore, in a case in which a magnetic force M between the first magnet portion 4 and the second magnet portion 5 is sufficiently strong, a weight of the second magnet portion 5 can be supported due to the magnetic force M and the second magnet portion 5 can be held on the bottom surface 34s of the recessed portion 34 even when there is no locking projection 34a. Thus, in the SERS unit 1, the SERS element 2 is fixed to the handling plate 3 due to a magnetic force M in a state in which the SERS element 2 is spaced apart from the second magnet portion 5 (that is, a state in which the portion 3a of the handling plate 3 is interposed between the SERS element 2 and the second magnet portion 5). That is, in the SERS unit 1, the SERS element 2 is not mechanically fixed to the handling plate 3 through fitting to the recessed portion 33, or the like.

Therefore, when the magnetic force M is not generated, the SERS element 2 is not fixed to the handling plate 3, and can be taken in or out from the recessed portion 33 (that is, can be detached from the handling plate 3). The magnetic force M has a magnitude to a degree required and sufficient to fix the SERS element 2 to the handling plate 3. Therefore, a magnetic force M does not affect Raman spectroscopic analysis using the SERS unit 1 as described below.

Both of the first magnet portion 4 and the second magnet portion 5 may be formed of permanent magnets, or one thereamong may be formed of a permanent magnet and the other may be formed of a temporary magnet. Further, here, the permanent magnet is made of a substance that holds a property of a magnet for a long period of time without being supplied with a magnetic field or a current from the outside. Further, here, the temporary magnet is made of a substance having a property of a magnet only while being magnetized from the outside.

Here, for example, the first magnet portion 4 includes a temporary magnet (is formed of, for example, a temporary magnet). Further, the second magnet portion 5 includes a permanent magnet (is formed of, for example, a permanent magnet). Examples of the temporary magnet of the first magnet portion 4 may include soft iron (pure iron), silicon steel (alloy obtained by adding Si to Fe), permalloy (Fe—Ni alloy), sendust (Fe—Si—Al alloy), permendur (Fe—Co alloy), an amorphous magnetic alloy (for example, a Pd—Si—Cu alloy and a Zr alloy), and a nanocrystalline magnetic alloy (Fe—Zr—B—Cu alloy).

Examples of the permanent magnet of the second magnet portion 5 may include a ferrite magnet, a metal magnet, and a bonded magnet. Examples of the ferrite magnet may include a barium ferrite magnet and a strontium ferrite magnet.

The metal magnet is, for example, an alloy magnet or a rare earth magnet. The alloy magnet is, for example, a Fe—Cr—Co magnet, an alnico magnet, a Fe—Mn magnet, a Mn—Al magnet, a Mn—Al—C magnet, or a platinum magnet. The rare earth magnet is, for example, a samarium cobalt magnet, a neodymium magnet, or a praseodymium magnet.

The bonded magnet is, for example, a rubber magnet or a plastic magnet. The rubber magnet is, for example, a ferrite rubber magnet (rubber magnet), or a neodymium rubber magnet. The plastic magnet is, for example, a ferrite plastic magnet or a neodymium plastic magnet.

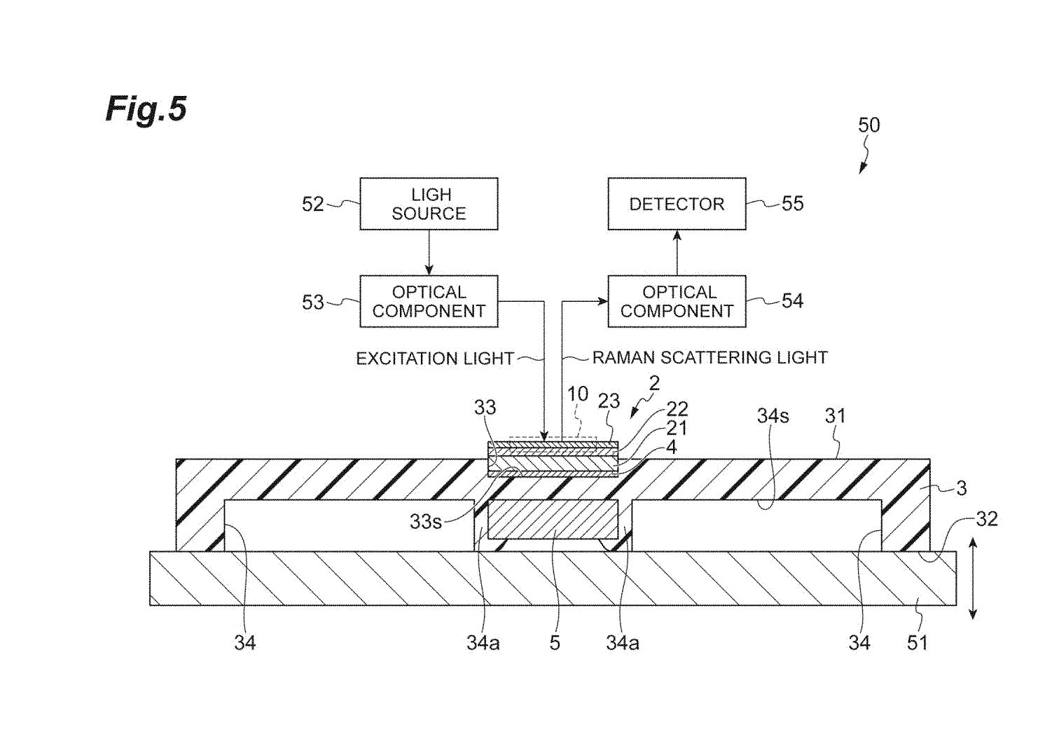

A Raman spectroscopic analysis method using the SERS unit 1 configured as described above will be described. Here, the Raman spectroscopic analysis method using the SERS unit 1 is performed using a Raman spectroscopic analysis device 50, as illustrated in FIG. 5. The Raman spectroscopic analysis device 50 includes a stage 51, a light source 52, optical components 53 and 54, and a detector 55. The stage 51 supports the SERS unit 1. The light source 52 emits excitation light. The optical component 53 performs collimation, filtering, condensing, and the like required to irradiate the optical functional portion 10 with the excitation light. The optical component 54 performs collimation, filtering, and the like required to guide Raman scattered light to the detector 55. The detector 55 detects Raman scattering light.

Here, first, the SERS unit 1 is prepared and a solution sample (or a sample in which a powder sample is dispersed in a solution such as water or ethanol (the same applies hereinafter)) is dropped to the optical functional portion 10 of the SERS element 2 so as to arrange the solution sample on the optical functional portion 10. When the solution sample is dropped, a spacer made of silicone or the like may be arranged on the handling plate 3 in advance so as to form a sample cell. Thereafter, the handling plate 3 is arranged on the stage 51, and the SERS unit 1 is set in the Raman spectroscopic analysis device 50.

Subsequently, the solution sample on the optical functional portion 10 is irradiated with the excitation light emitted from the light source 52 via the optical component 53 so that the solution sample is excited. At this time, the stage 51 is moved so that the excitation light is focused on the optical functional portion 10. Accordingly, surface-enhanced Raman scattering occurs at an interface between the optical functional portion 10 and the solution sample and Raman scattering light from the solution sample is enhanced to, for example, 10⁸ times and emitted. The emitted Raman scattered light is detected by the detector 55 through the optical component 54, and Raman spectroscopic analysis is performed.

Methods of arranging a sample on the optical functional portion 10 include the following methods, in addition to the above-described method. For example, the handling plate 3 may be grasped, and the SERS element 2 may be immersed in the solution sample, pulled up, and blown to dry the sample. Further, a small amount of a solution sample may be dropped onto the optical functional portion 10, and the sample may be naturally dried. Further, a sample which is a powder may be directly dispersed on the optical functional portion 10.

As described above, in the SERS unit 1 according to this embodiment, the SERS element 2 having the optical functional portion 10 is fixed to the handling plate 3 due to a magnetic force M. Therefore, the optical functional portion 10 can be prevented from deteriorating due to components contained in the adhesive, for example, unlike a case in which the SERS element 2 is fixed to the handling plate 3 with an adhesive. Further, the optical functional portion 10 can be prevented from deteriorating due to physical interference between the holding member and the optical functional portion 10, unlike a case in which the SERS element 2 is mechanically fixed to the handling plate 3 by the holding member. Thus, according to this SERS unit 1, it is possible to suppress the deterioration of the optical functional portion 10.

In particular, in the SERS unit 1 according to this embodiment, a member that contacts a surface of the SERS element 2 (a surface on the side of the optical functional portion 10) is not required in order to mechanically fix the SERS element 2 to the handling plate 3. Therefore, it is possible to secure an area for the optical functional portion 10 over a wide range of the surface (for example, the entire surface) of the SERS element 2. Therefore, the surface-enhanced Raman scattering light can be easily acquired.

Further, in the SERS unit 1 according to this embodiment, a magnetic force M for fixing the SERS element 2 to the handling plate 3 is an attractive force. A structure for fixing the SERS element 2 to the handling plate 3 can be realized even when a magnetic force M is a repulsive force, but a structure for fixing the SERS element 2 to the handling plate 3 can be simplified when a magnetic force M is the attractive force.

Further, in the SERS unit 1 according to this embodiment, the SERS element 2 is arranged in the recessed portion 33 provided in the handling plate 3. Therefore, the SERS element 2 can be positioned, for example, in a direction along a main surface 31 of the handling plate 3 by an inner wall of the recessed portion 33.

Further, in the SERS unit 1 according to this embodiment, the SERS element 2 is fixed to the handling plate 3 due to a magnetic force M between the first magnet portion 4 and the second magnet portion 5. Accordingly, if a magnitude of a magnetic force M is adjusted by, for example, selection of the materials of the first magnet portion 4 and the second magnet portion 5, fixation strength between the SERS element 2 and the handling plate 3 can be controlled.

Further, in the SERS unit 1 according to this embodiment, the SERS element 2 includes the first magnet portion 4 and is fixed to the handling plate 3 by a magnetic force M in a state in which the SERS element 2 is spaced apart from the second magnet portion 5. Thus, for example, a degree of freedom in molding the handling plate 3 is higher than that when the second magnet portion 5 is embedded in the handling plate 3 and brought into contact with the SERS element 2.

According to the SERS unit 1 according to this embodiment, the SERS element 2 is easily attached to or detached from the handling plate 3 in comparison with a case in which the SERS element 2 is fixed by an adhesive or a holding member. Further, since a process of fixing the SERS element 2 to the handling plate 3 is simplified, a risk of damage to the SERS element 2 in assembly of the SERS unit 1 is reduced.

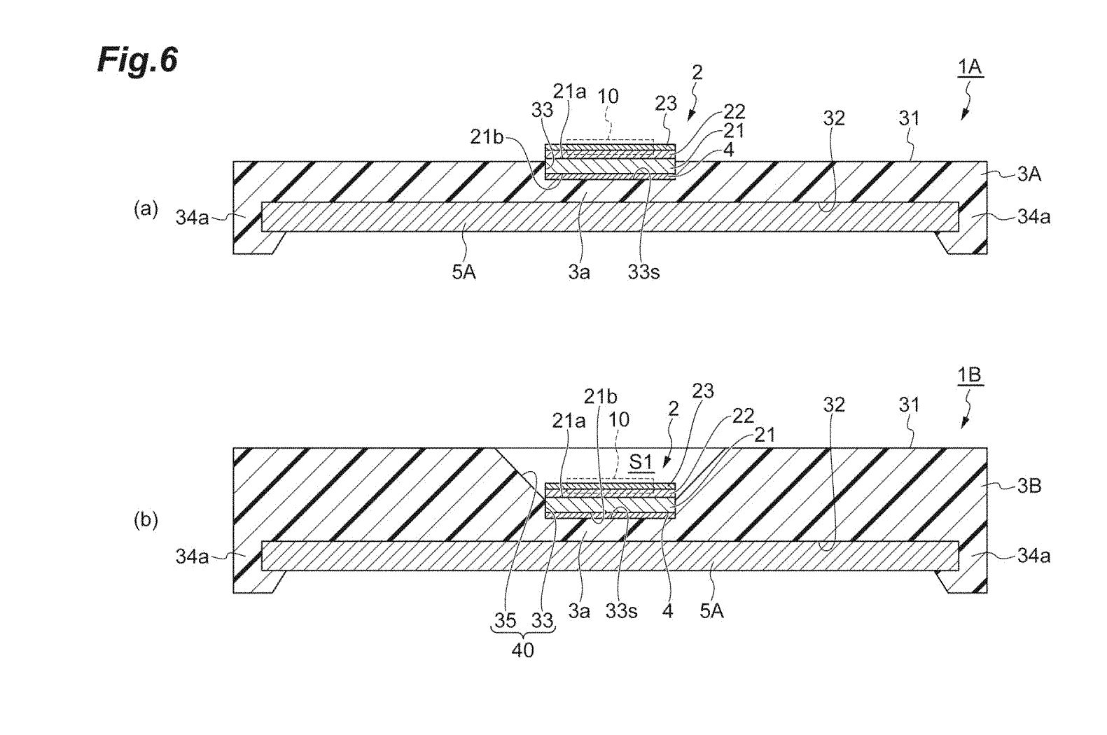

Subsequently, a modification example of the SERS unit 1 according to this embodiment will be described. FIG. 6 is a cross-sectional view illustrating a modification example of the surface-enhanced Raman scattering unit illustrated in FIG. 2. As illustrated in FIG. 6(a), an SERS unit (surface-enhanced Raman scattering unit) 1A is different from the SERS unit 1 in that a handling plate (support member) 3A is included in place of the handling plate 3, and a second magnet portion 5A is included in place of the second magnet portion 5 in comparison with the SERS unit 1. The handling plate 3A is formed of the same material as that of the handling plate 3 using the same scheme as that for the handling plate 3. Further, the second magnet portion 5A is formed of the same material as that of the second magnet portion 5.

The handling plate 3A includes a main surface 31 and a back surface (second surface) 32, and has a rectangular plate shape. A recessed portion 33 is formed in the main surface 31. A bottom surface (first surface) 33s of the recessed portion 33 and the back surface 32 extend substantially in parallel in a state in which the bottom surface 33s and the back surface 32 are spaced apart from each other. Thus, a portion 3a of the handling plate 3 is interposed between the bottom surface 33s and the back surface 32. The SERS element 2 is arranged in the recessed portion 33. For example, the SERS element 2 is arranged on the bottom surface 33s so that the first magnet portion 4 is brought into contact with the bottom surface (first surface) 33s of the recessed portion 33.

The second magnet portion 5A has a rectangular plate shape. The second magnet portion 5A is arranged on the back surface 32 of the handling plate 3A. The second magnet portion 5A extends over substantially the entire back surface 32 other than an outer edge of the back surface 32. A locking projection 34a projects from the outer edge of the back surface 32. The second magnet portion 5A is fitted (locked) to the locking projection 34a and held on the back surface 32.

Accordingly, in the SERS unit 1A, the SERS element 2 and the second magnet portion 5A are close to each other and face each other in a state in which the portion 3a of the handling plate 3A is interposed therebetween. That is, in the SERS unit 1A, the SERS element 2 is fixed to the handling plate 3A due to a magnetic force M between the first magnet portion 4 and the second magnet portion 5A in a state in which the SERS element 2 is spaced apart from the second magnet portion 5A.

According to such an SERS unit 1A, it is possible to further achieve the following effects in addition to the same effects as those of the SERS unit 1 described above. That is, in the SERS unit 1A, the second magnet portion 5A extends over substantially the entire back surface 32 of the handling plate 3A and is fitted to the handling plate 3A by the locking projection 34a. Therefore, Raman scattering can be stably detected as a result of correction of deformation such as warpage of the handling plate 3A.

As illustrated in FIG. 6B, the SERS unit (surface-enhanced Raman scattering unit) 1B is different from the SERS unit 1 in that a handling plate (support member) 3B is included in place of the handling plate 3 and that a second magnet portion 5A is included in place of the second magnet portion 5 in comparison with the SERS unit 1. The handling plate 3B is formed of the same material as that of the handling plate 3 using the same scheme as that for the handling plate 3.

The handling plate 3B includes a main surface 31 and a back surface (second surface) 32, and has a rectangular plate shape. A recessed portion 33 is formed in the main surface 31. A tapered recessed portion 35 that expands in a direction from the back surface 32 to the main surface 31 is formed in the main surface 31. The recessed portion 33 is formed in the bottom surface of the recessed portion 35. The recessed portion 33 and the recessed portion 35 are continuous to each other, and constitute a single recessed portion 40. The recessed portion 40 is arranged substantially at a center in a longitudinal direction and a lateral direction of the handling plate 3B.

The SERS element 2 is arranged in the recessed portion 40. More specifically, the SERS element 2 is arranged on the bottom surface 33s so that a first magnet portion 4 is brought into contact with the bottom surface (first surface) 33s of the recessed portion 33, and is accommodated in the recessed portion 40. Here, the entire SERS element 2 is accommodated in the recessed portion 40. In particular, a dimension (a depth) of the recessed portion 40 is greater than a dimension (thickness) of the SERS element 2 in a thickness direction of the handling plate 3B (a direction intersecting the main surface 31). Therefore, an optical functional portion 10 of the SERS element 2 is arranged inside the recessed portion 40 relative to the main surface 31. Further, a space S1 defined by an inner surface of the recessed portion 40 is provided on the optical functional portion 10 of the SERS element 2.

Meanwhile, a second magnet portion 5A is arranged on the back surface 32 of the handling plate 3B. The second magnet portion 5A extends over substantially the entire back surface 32 other than an outer edge of the back surface 32. A locking projection 34a projects at the outer edge of the back surface 32. The second magnet portion 5A is fitted to (locked) the locking projection 34a and held on the back surface 32.

Accordingly, in the SERS unit 1B, the SERS element 2 and the second magnet portion 5A are close to each other and face each other in a state in which a portion 3a of the handling plate 3B is interposed therebetween. That is, in the SERS unit 1B, the SERS element 2 is fixed to the handling plate 3B due to a magnetic force M between the first magnet portion 4 and the second magnet portion 5A in a state in which the SERS element 2 is spaced apart from the second magnet portion 5A.

According to such an SERS unit 1B, it is possible to further achieve the following effects, in addition to the same effects as those of the SERS unit 1 described above. That is, in the SERS unit 1B, the second magnet portion 5A extends over substantially the entire back surface 32 of the handling plate 3B and is fitted to the handling plate 3A by the locking projection 34a. Therefore, it is possible to stably detect Raman scattering as a result of correction of deformation such as warpage of the handling plate 3B.

Further, in the SERS unit 1B, the optical functional portion 10 of the SERS element 2 is arranged inside the recessed portion 40 relative to the main surface 31 of the handling plate 3B. Therefore, a risk of contact with the optical functional portion 10 or contamination of the optical functional portion 10 can be reduced. Further, a space S1 defined by the inner surface of the recessed portion 40 is provided on the optical functional portion 10. Therefore, when Raman spectroscopic analysis using this SERS unit 1B is performed, the recessed portion 40 may be used as a cell (chamber) of a solution sample. Further, since the recessed portion 40 is tapered, generation of stray light due to reflection at the inner surface of the recessed portion 40 can be suppressed.

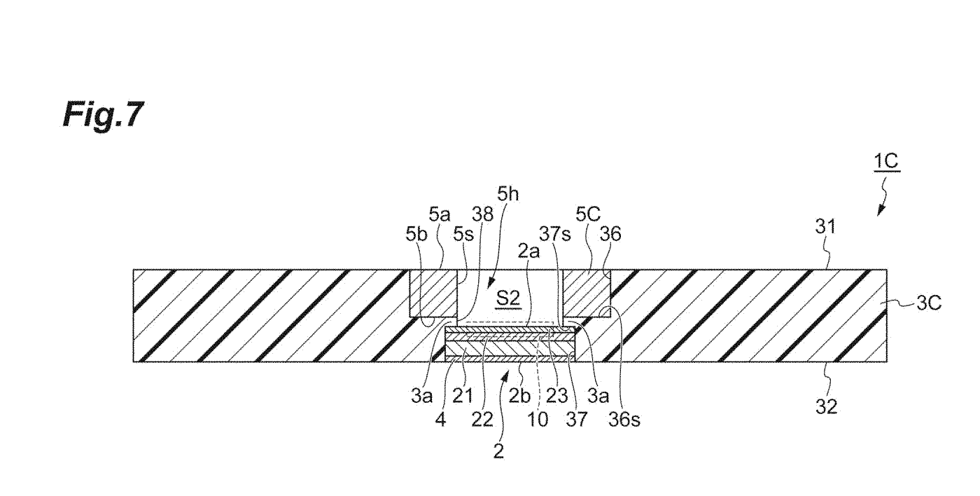

FIG. 7 is a cross-sectional view illustrating a modification example of the surface-enhanced Raman scattering unit illustrated in FIG. 2. As illustrated in FIG. 7, the SERS unit (surface-enhanced Raman scattering unit) 1C is different from the SERS unit 1 in that a handling plate (support member) 3C is included in place of the handling plate 3, and that a second magnet portion 5C is included in place of the second magnet portion 5 in comparison with the SERS unit 1. The handling plate 3C is formed of the same material as that of the handling plate 3 using the same scheme as that for the handling plate 3. Further, the second magnet portion 5C is formed of the same material as that of the second magnet portion 5.

The handling plate 3C includes a main surface 31 and a back surface 32, and has a rectangular plate shape. A recessed portion 36 is formed in the main surface 31. Further, a recessed portion 37 is formed in a back surface 32. The recessed portion 36 and the recessed portion 37 are arranged substantially at a center in a longitudinal direction and a lateral direction of the handling plate 3. The recessed portion 36 and the recessed portion 37 are formed in a rectangular parallelepiped shape. Further, the recessed portion 36 and the recessed portion 37 overlap each other when viewed from a thickness direction of the handling plate 3C (a direction intersecting the main surface 31).

A bottom surface (second surface) 36s of the recessed portion 36 and a bottom surface (first surface) 37s of the recessed portion 37 extend substantially in parallel in a state in which the bottom surfaces are spaced apart from each other. Thus, a portion 3a of the handling plate 3C is interposed between the bottom surface 36s and the bottom surface 37s. In this portion 3a, a communication hole 38 through which the bottom surface 36s and the bottom surface 37s are in communication with each other is formed. Thus, the recessed portion 36 and the recessed portion 37 are in communication with each other via the communication hole 38.

The SERS element 2 is arranged in the recessed portion 37. More specifically, the SERS element 2 is arranged on the bottom surface 37s so that an outer edge of a surface (a surface on the optical functional portion 10 side) 2a of the SERS element 2 is brought into contact with the bottom surface 37s of the recessed portion 37. Here, for example, a dimension (depth) of the recessed portion 37 is substantially the same as a dimension (thickness) of the SERS element 2 in a thickness direction of the handling plate 3C. Accordingly, the entire SERS element 2 is accommodated in the recessed portion 37 and a back surface (a surface on the back surface 21b side of the substrate 21) 2b of the SERS element 2 is substantially flush with the back surface 32.

Meanwhile, the second magnet portion 5C is arranged in the recessed portion 36. More specifically, the second magnet portion 5C is arranged on the bottom surface 36s so that a back surface 5b thereof is brought into contact with the bottom surface 36s of the recessed portion 36. Here, for example, a dimension (depth) of the recessed portion 36 is substantially the same as a dimension (thickness) of the second magnet portion 5C in a thickness direction of the handling plate 3C. Accordingly, the second entire magnet portion 5C is accommodated in the recessed portion 36, and a surface 5a of the second magnet portion 5C is substantially flush with the main surface 31.

Thus, in the SERS unit 1C, the SERS element 2 and the second magnet portion 5C are close to each other and face each other in a state in which the portion 3a of the handling plate 3C is interposed therebetween. That is, in the SERS unit 1C, the SERS element 2 is fixed to the handling plate 3C due to a magnetic force M between the first magnet portion 4 and the second magnet portion 5C in a state in which the SERS element 2 is spaced apart from the second magnet portion 5C.

Here, a hole portion 5h is provided in the second magnet portion 5C so that the optical functional portion 10 of the SERS element 2 is exposed at the main surface 31 side of the handling plate 3C through the communication hole 38. For example, the second magnet portion 5C is formed in an annular shape due to the hole portion 5h. Therefore, a space S2 defined by an inner surface 5s (an inner surface of the second magnet portion 5C) of the hole portion 5h of the second magnet portion 5C is provided on the optical functional portion 10 of the SERS element 2.

According to such an SERS unit 1C, it is possible to further achieve the following effects, in addition to the same effects as those of the SERS unit 1 described above. That is, in the SERS unit 1C, the optical functional portion 10 of the SERS element 2 is exposed at the main surface 31 side of the handling plate 3C through the hole portion 5h of the second magnet portion 5C. Therefore, a risk of contact with the optical functional portion 10 of the SERS element 2 or contamination of the optical functional portion 10 can be reduced.

Further, a space S2 defined by an inner surface 5s of the hole portion 5h is provided on the optical functional portion 10 of the SERS element 2. Therefore, when the Raman spectroscopic analysis using this SERS unit 1C is performed, the hole portion 5h (that is, the second magnet portion 5C) may be used as a cell (chamber) for a solution sample. Further, in the SERS unit 1C, the second entire magnet portion 5C is accommodated in the recessed portion 36 of the main surface 31, and the entire SERS element 2 is accommodated in the recessed portion 37 of the back surface 32. Therefore, it is possible to thin the entire handling plate 3C.

Here, an effect in which an area for the optical functional portion 10 can be secured over a wide range of the surface 2a of the SERS element 2 in the SERS unit 1C will be described. In the SERS unit 1C, an outer edge of the surface 2a of the SERS element 2 is brought into contact with the portion 3a of the handling plate 3C (a bottom surface 37s of the recessed portion 37). Therefore, it is difficult for the area of the surface 2a of the SERS element 2 brought into contact with the portion 3a to be caused to function as the optical functional portion 10.

However, for example, in a case in which the SERS element 2 is mechanically fixed to the handling plate 3 by a holding member that presses the surface of the SERS element 2, it is necessary for a relatively large area on the surface 2a of the SERS element 2 to be pressed by the holding member in order to sufficiently press the SERS element 2 to the handling plate 3. That is, in this case, a relatively large area of the surface 2a of the SERS element 2 is brought into contact with the holding member and cannot function as the optical functional portion 10.

On the other hand, in the SERS unit 1C, the portion 3a in an area that is relatively narrow to regulate the movement of the SERS element 2 due to a magnetic force M may be brought into contact with the surface 2a. Therefore, it is possible to expose a relatively large area of the surface 2a of the SERS element 2 and cause the area to function as the optical functional portion 10 in comparison with a case in which the SERS element 2 is mechanically fixed by a holding member. Therefore, according to the SERS unit 1C, an area for the optical functional portion 10 can be secured over a wide range of the surface 2a of the SERS element 2.

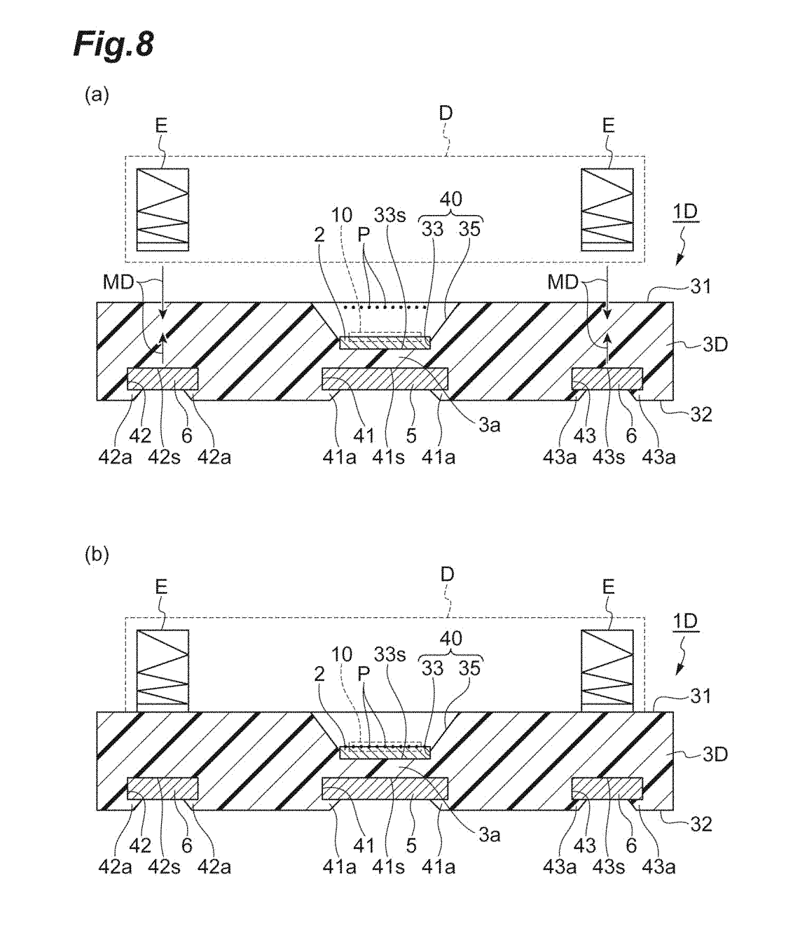

FIG. 8 is a schematic cross-sectional view illustrating a modification example of the surface-enhanced Raman scattering unit illustrated in FIG. 2. As illustrated in FIG. 8, an SERS unit (surface-enhanced Raman scattering unit) 1D is different from the SERS unit 1 in that a handling plate (support member) 3D is included in place of the handling plate 3, and a pair of third magnet portions 6 are further included. The handling plate 3D is formed of the same material as that of the handling plate 3 using the same scheme as that for the handling plate 3. Further, the third magnet portion 6 is formed of the same material as that of the first magnet portion 4 or the second magnet portion 5.

The handling plate 3D includes a main surface 31 and a back surface 32 opposite to the main surface 31, and has a rectangular plate shape. A recessed portion 40 is formed of a recessed portion 33 and a recessed portion 35 in the main surface 31. On the other hand, a plurality of recessed portions are formed in the back surface 32. More specifically, a recessed portion 41, a recessed portion 42, and a recessed portion 43 are formed in the back surface 32. The recessed portions 41 to 43 are formed in a rectangular parallelepiped shape. The recessed portion 41 is arranged substantially at a center in a longitudinal direction and a lateral direction of the handling plate 3D.

Therefore, a bottom surface (second surface) 41s of the recessed portion 41 and a bottom surface (first surface) 33s of the recessed portion 33 overlap each other when viewed from a thickness direction of the handling plate 3D (a direction intersecting the main surface 31). Further, the bottom surface 33s and the bottom surface 41s extend substantially in parallel in a state in which the bottom surfaces are spaced apart from each other. Thus, the portion 3a of the handling plate 3D is interposed between the bottom surface 33s and the bottom surface 41s. A locking claw 41a is provided in an opening portion of the recessed portion 41. The recessed portion 42 and the recessed portion 43 are formed in end portions in a longitudinal direction of the handling plate 3D, respectively. A locking claw 42a and a locking claw 43a are provided in an opening portion of the recessed portion 42 and an opening portion of the recessed portion 43, respectively.

The SERS element 2 is arranged in the recessed portion 40, as in the case of the SERS unit 1B. That is, the SERS element 2 is arranged on the bottom surface 33s of the recessed portion 33 so that the first magnet portion 4 is brought into contact with the bottom surface 33s of the recessed portion 33, and is accommodated in the recessed portion 40. Meanwhile, the second magnet portion 5 is arranged in the recessed portion 41. More specifically, the second magnet portion 5 is locked by the locking claws 41a in a state in which the second magnet portion 5 is inserted into the recessed portion 41, and is held (arranged) on the bottom surface 41s of the recessed portion 41.

Thus, the second magnet portion 5 and the SERS element 2 are close to each other and face each other in a state in which the portion 3a of the handling plate 3D is interposed therebetween. That is, in the SERS unit 1D, the SERS element 2 is fixed to the handling plate 3D due to a magnetic force M between the first magnet portion 4 and the second magnet portion 5 in a state in which the SERS element 2 is spaced apart from the second magnet portion 5.

One of the third magnet portions 6 is arranged in the recessed portion 42. More specifically, one of the third magnet portions 6 is locked by the locking claws 42a in a state in which the one of the third magnet portions 6 is inserted into the recessed portion 42, and is held (arranged) on the bottom surface 42s of the recessed portion 42. The other of the third magnet portions 6 is arranged in the recessed portion 43. More specifically, the other of the third magnet portions 6 is locked by the locking claws 43a in a state in which the other of the third magnet portions 6 is inserted into the recessed portion 43, and is held (arranged) on the bottom surface 43s of the recessed portion 43.

According to the SERS unit 1D, it is possible to further achieve the following effects, in addition to the same effects as those of the SERS unit 1. That is, according to the SERS unit 1D, a risk of contact with the optical functional portion 10 of the SERS element 2 or contamination of the optical functional portion 10 can be reduced, for the same reason as the SERS unit 1B. When Raman spectroscopic analysis using this SERS unit 1D is performed, the recessed portion 40 may be used as a cell (chamber) for a solution sample. Further, since the recessed portion 40 is tapered, generation of stray light due to reflection at the inner surface of the recessed portion 40 can be suppressed.

Further, in the SERS unit 1D, the third magnet portions 6 are arranged in the recessed portion 42 and the recessed portion 43 at both end portions in a longitudinal direction of the handling plate 3D. Therefore, for example, if an electromagnet E is provided at a position corresponding to the third magnet portion 6 in a measurement device D such as the above-described Raman spectroscopic analysis device 50, the measurement device D and the SERS unit 1D can attract each other due to a magnetic force MD between the electromagnet E and the third magnet portion 6. Accordingly, for example, when the measurement device D approaches the SERS unit 1D until the electromagnet E is brought into contact with the main surface 31, alignment can be automatically performed so that a focal point P of an optical system of the measurement device D coincides with the optical functional portion 10 of the SERS element 2.

Further, if a size of the third magnet portion 6 when viewed from the thickness direction of the handling plate 3D (a direction intersecting the main surface 31) is appropriately set (for example, if a size of a section of the third magnet portion 6 is set with the same degree as the size of the section of the electromagnet E), alignment of arrangement of the SERS unit 1D in a direction along the main surface 31 of the handling plate 3D can also be appropriately performed due to a magnetic force MD between the third magnet portion 6 and the electromagnet E. Further, if a guide groove of the electromagnet E is provided at an appropriate position of the main surface 31 of the handling plate 3D, it is possible to reliably align the arrangement of the SERS unit 1D in a direction along the main surface 31 of the handling plate 3D.

Hereinafter, an example in which the SERS element 2 is movable along a surface on which the SERS element 2 is arranged according to the movement of the second magnet portion will be described.

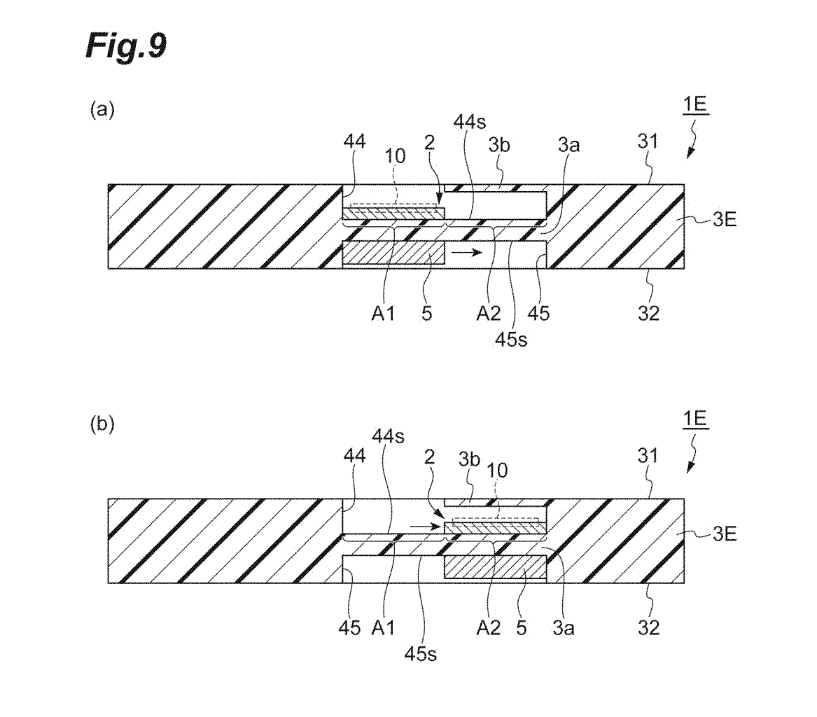

FIG. 9 is a schematic cross-sectional view illustrating a modification example of the surface-enhanced Raman scattering unit illustrated in FIG. 2. As illustrated in FIG. 9, an SERS unit (surface-enhanced Raman scattering unit) 1E is different from the SERS unit 1 in that a handling plate (support member) 3E is included in place of the handling plate 3. The handling plate 3E is formed of the same material as that of the handling plate 3 using the same scheme as that for the handling plate 3.

The handling plate 3E includes a main surface 31 and a back surface 32, and has a rectangular plate shape. A recessed portion 44 is formed in the main surface 31. The recessed portion 44 is formed in a rectangular parallelepiped shape. A bottom surface (first surface) 44s of the recessed portion 44 includes two functional areas A1 and A2 arranged in a longitudinal direction of the handling plate 3E. The bottom surface 44s is exposed at the main surface 31 side in the functional area A1. On the other hand, the bottom surface 44s is covered with a thin plate-shaped extension portion 3b extending along the main surface 31 of the handling plate 3E in the functional area A2.

Meanwhile, a recessed portion 45 is formed in the back surface 32. The recessed portion 45 is formed in a rectangular parallelepiped shape. The recessed portion 45, here, is formed with substantially the same size at substantially the same position as that of the recessed portion 44 when viewed from a thickness direction of the handling plate 3E (a direction intersecting the main surface 31). Thus, the bottom surface 44s of the recessed portion 44 and a bottom surface (second surface) 45s of the recessed portion 45 overlap each other when viewed from a thickness direction of the handling plate 3E. Further, the bottom surface 44s and the bottom surface 45s extend substantially in parallel in a state in which the bottom surfaces are spaced apart from each other. Therefore, the portion 3a of handling plate 3E is interposed between the bottom surface 44s and the bottom surface 45s.

The SERS element 2 is arranged in the recessed portion 44. More specifically, the SERS element 2 is arranged on the bottom surface 44s so that first magnet portion 4 is brought into contact with the bottom surface 44s of the recessed portion 44. The entire SERS element 2 is accommodated in the recessed portion 44. In a thickness direction of the handling plate 3E, a dimension (depth) of the recessed portion 44 is greater than a dimension (thickness) of the SERS element 2. Therefore, the optical functional portion 10 of the SERS element 2 is arranged inside the recessed portion 44 relative to the main surface 31. Meanwhile, the second magnet portion 5 is arranged in the recessed portion 45. More specifically, the second magnet portion 5 is arranged on the bottom surface 45s of the recessed portion 45 so that the second magnet portion 5 is brought into contact with the bottom surface 45s of the recessed portion 45. The entire second magnet portion 5, for example, is accommodated in the recessed portion 45.

Thus, in the SERS unit 1E, the SERS element 2 is fixed to the handling plate 3E due to a magnetic force M between the first magnet portion 4 and the second magnet portion 5 in a state in which the SERS element 2 is spaced apart from the second magnet portion 5. Further, the SERS element 2 is caused to follow the second magnet portion 5 due to a magnetic force M between the first magnet portion 4 and the second magnet portion 5 by moving the second magnet portion 5 along the bottom surface 45s of the recessed portion 45. Thus, the SERS element 2 can be moved along the bottom surface 44s of the recessed portion 44.

According to such an SERS unit 1E, it is possible to further achieve the following effects, in addition to the same effects as those of the SERS unit 1 described above. That is, in the SERS unit 1E, the optical functional portion 10 of the SERS element 2 is arranged inside the recessed portion 44 relative to the main surface 31 of the handling plate 3E. Therefore, a risk of contact with the optical functional portion 10 of the SERS element 2 or contamination of the optical functional portion 10 can be reduced.

Further, in the SERS unit 1E, the SERS element 2 is movable along the bottom surface 44s of the recessed portion 44 according to the movement of the second magnet portion 5 along the bottom surface 45s of the recessed portion 45. Therefore, according to the SERS unit 1E, the SERS element 2 can be easily arranged at a desired position.

In particular, the bottom surface 44s of the recessed portion 44 includes two functional areas A1 and A2. Thus, if the SERS element 2 is slid on the bottom surface 44s to follow the second magnet portion 5 due to a magnetic force M between the first magnet portion 4 and the second magnet portion 5 by sliding the second magnet portion 5 on the bottom surface 45s of the recessed portion 45, the arrangement of the SERS element 2 can be changed between the functional area A1 and the functional area A2. The bottom surface 44s is exposed at the main surface 31 side in the functional area A1, and covered with the extension portion 3b of the handling plate 3E in the functional area A2.

Thus, for example, only when measurement such as Raman spectroscopic analysis is performed, the SERS element 2 is positioned on the functional area A1 due to the sliding of the second magnet portion 5 to expose the optical functional portion 10 at the main surface 31 side and, otherwise, the SERS element 2 is positioned on the functional area A2 so that the optical functional portion 10 can be covered with the extension portion 3b. Therefore, according to the SERS unit 1E, it is possible to minimize the risk of contact with the optical functional portion 10 or contamination of the optical functional portion 10 by exposing the optical functional portion 10, only if necessary.

The functional area A1 is a measurement area having a function of enabling measurement using the SERS element 2 by exposing the optical functional portion 10 at the main surface 31 side, as described above. Further, the functional area A2 is a storage area having a function of storing the SERS element 2 in a state in which the optical functional portion 10 is protected by the extension portion 3b, as described above.

The SERS unit 1E may include a slide tray (not illustrated) that slides on the bottom surface 44s of the recessed portion 44 to follow the second magnet portion 5 due to the magnetic force with the second magnet portion 5 when the second magnet portion 5 is slid on the bottom surface 45s of the recessed portion 45. The slide tray includes a temporary magnet or a permanent magnet (or, is configured with the temporary magnet or the permanent magnet) to cause a magnetic force to be generated with the second magnet portion 5. In this case, if the SERS element 2 is placed on the slide tray, it is possible to achieve the above-described effects.

Further, if the SERS element 2 is fixed to the slide tray, the SERS element 2 may not include the first magnet portion 4. However, if the SERS element 2 includes the first magnet portion 4, the SERS element 2 can be fixed to the slide tray by magnetic force. In this case, the SERS element 2 is fixed to the handling plate 3E by magnetic force via the slide tray and the second magnet portion 5.

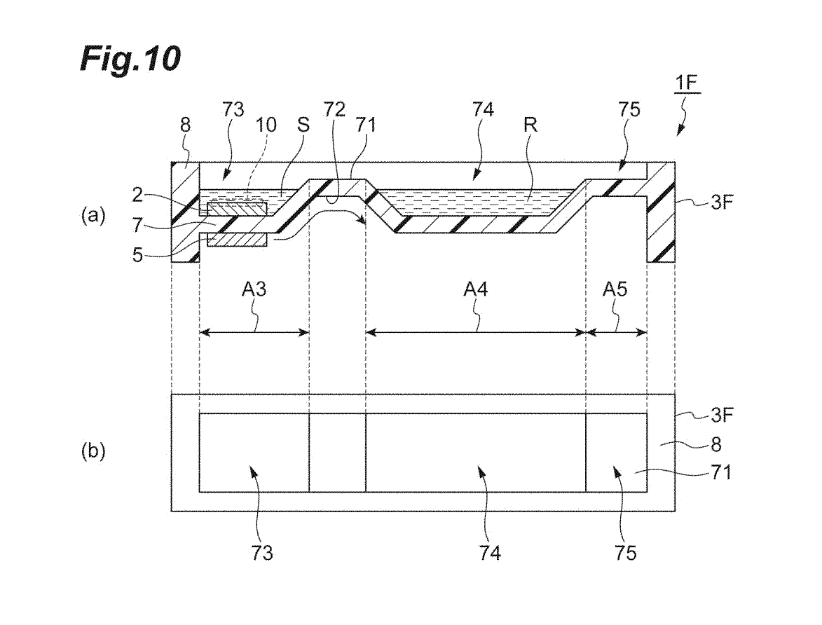

FIG. 10 is a schematic view illustrating a modification example of the surface-enhanced Raman scattering unit illustrated in FIG. 2. FIG. 10(a) is a schematic cross-sectional view, and FIG. 10(b) is a schematic plan view. As illustrated in FIG. 10, an SERS unit (surface-enhanced Raman scattering unit) 1F is different from the SERS unit 1 in that a handling plate (support member) 3F is included in place of the handling plate 3 in comparison with the SERS unit 1. The handling plate 3F is formed of the same material as that of the handling plate 3 using the same scheme as that for the handling plate 3.

The handling plate 3F is formed in an elongated plate shape. The handling plate 3F includes an inner portion 7 and an outer portion 8. The inner portion 7 extends in a longitudinal direction of the handling plate 3F. The inner portion 7 has a plate-like shape undulating in the longitudinal direction of the handling plate 3F. The outer portion 8 is erected in an annular shape along an edge of the inner portion 7 to surround the inner portion 7. The outer portion 8 constitutes an outer wall portion of the handling plate 3. The inner portion 7 and the outer portion 8 are formed integrally with each other.

The inner portion 7 includes a main surface (first surface) 71, and a back surface (second surface) 72 opposite to the main surface 71. The main surface 71 and the back surface 72 extend substantially in parallel to each other. Therefore, undulations of the main surface 71 and the undulations of the back surface 72 are in a complementary relationship. The SERS element 2 is arranged on the main surface 71, and the second magnet portion 5 is arranged on the back surface 72. Accordingly, in the SERS unit 1F, the SERS element 2 is fixed to the handling plate 3F due to a magnetic force M between the first magnet portion 4 and the second magnet portion 5 in a state in which the SERS element 2 is spaced apart from the second magnet portion 5.

Further, the SERS element 2 is caused to follow the second magnet portion 5 due to a magnetic force M between the first magnet portion 4 and the second magnet portion 5 by moving the second magnet portion 5 along the back surface 72. Thus, the SERS element 2 can be moved along the main surface 71.

A recessed portion 73, a recessed portion 74, and a flat portion 75 arranged in a longitudinal direction of the handling plate 3F are provided in the main surface 71. A solution sample S, for example, is stored in the recessed portion 73. A rinse liquid R, for example, is stored in the recessed portion 74. In the SERS unit 1F, for example, first, the SERS element 2 is arranged on a bottom surface of the recessed portion 73, and a second magnet portion 5 is arranged on the back surface 72 on the opposite side. Thus, the SERS element 2 is fixed to the handling plate 3F due to a magnetic force M in the recessed portion 73 and immersed in the solution sample S stored in the recessed portion 73, and the solution sample is arranged in the optical functional portion 10.

In this state, by sliding the second magnet portion 5 on the back surface 72, the SERS element 2 is slid on the main surface 71 to follow the second magnet portion 5 due to a magnetic force M between the first magnet portion 4 and the second magnet portion 5, and is introduced into the recessed portion 74. Thus, the SERS element 2 is immersed into the rinse liquid R stored in the recessed portion 74. Due to the SERS element 2 being immersed into the rinse liquid R, only molecules that are measurement targets (analysis targets) in the solution sample arranged in the optical functional portion 10 remain in the optical functional portion 10.

Then, by further sliding the second magnet portion 5 on the back surface 72, the SERS element 2 is caused to be further slid on the main surface 71 to follow the second magnet portion 5 and positioned in the flat portion 75. The SERS element 2 arranged in the flat portion 75 is provided, for example, for measurement using a measurement device such as a Raman spectroscopic analysis device 50.

Thus, in the SERS unit 1F, the recessed portion 73, the recessed portion 74, and the flat portion 75 arranged in a longitudinal direction of the handling plate 3F are provided in the main surface 71. The recessed portion 73 is a functional area A3 in the main surface 71 and is an immersing area having a function of immersing the SERS element 2 into the solution sample S in order to arrange the solution sample in the optical functional portion 10. Further, the recessed portion 74 is a functional area A4 in the main surface 71 and is a rinse area having a function of causing only molecules of a measurement target (analysis target) in the solution sample arranged in the optical functional portion 10 to be left in the optical functional portion 10. Further, the flat portion 75 is a functional area A5 in the main surface 71 and is a measurement area having a function of performing measurement (for example, Raman spectroscopic analysis) using the SERS element 2.

According to such an SERS unit 1F, it is possible to further achieve the following effects, in addition to the same effects as those of the SERS unit 1 described above. That is, in the SERS unit 1F, the SERS element 2 is movable along the main surface 71 according to movement of the second magnet portion 5 along the back surface 72. Therefore, according to the SERS unit 1F, the SERS element 2 can be easily arranged at a desired position.

In particular, in the SERS unit 1F, the main surface 71 includes three functional areas A3 to A5. Thus, if the SERS element 2 is slid on the main surface 71 to follow the second magnet portion 5 due to a magnetic force M between the first magnet portion 4 and the second magnet portion 5 by sliding the second magnet portion 5 on the back surface 72, an arrangement of the SERS element 2 can be changed between the functional areas A3 to A5.

In particular, here, the functional area A3 is an immersion area for arranging a solution sample in the optical functional portion 10, the functional area A4 is a rinse area in which only molecules of a measurement target (analysis target) are left in the optical functional portion 10, and the functional area A5 is a measurement area in which measurement using the SERS element 2 is performed. Thus, if the SERS element 2 is slid on the main surface 71 to follow the sliding of the second magnet portion 5 on the back surface 72, a series of processes from the arrangement of a sample on the optical functional portion 10 to the measurement can be realized within the single SERS unit 1F.

Here, a form in which the main surface 71 and the back surface 72 are substantially in parallel to each other, and the back surface 72 undulates to follow the undulations of the main surface 71 has been described. However, the main surface 71 may have undulations as described above and the back surface 72 may be flat without following the undulations. In this case, it is possible to smoothly perform the movement of the second magnet portion 5 on the back surface 72.

As described above, in the SERS unit 1E or 1F, the surface (first surface) on which the SERS element 2 in the handling plate 3E or 3F is arranged includes a plurality of functional areas each having a specific function. The SERS element 2 is movable between the functional areas according to the movement of the second magnet portion 5 along the surface (second surface) opposite to the surface on which the SERS element 2 in the handling plate 3E or 3F is arranged. The specific function of the functional area is not limited to the above-described function, and can be, for example, an arbitrary function such as a function of holding the SERS element 2 in order to dry a solution sample arranged in the optical functional portion 10. Further, an arbitrary number of functional areas can be set according to the number of processes that are performed in the SERS element 2.

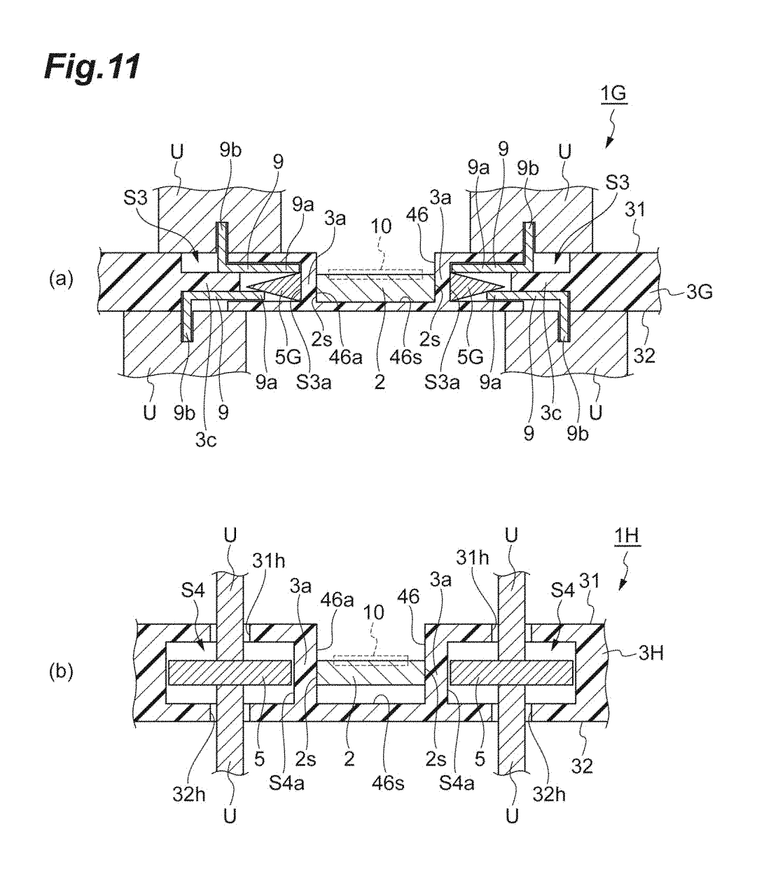

FIG. 11 is a schematic cross-sectional view illustrating a modification example of the surface-enhanced Raman scattering unit illustrated in FIG. 2. The SERS unit (surface-enhanced Raman unit) 1G illustrated in FIG. 11 (a) is different from the SERS unit 1 in that a handling plate (support member) 3G is included in place of the handling plate 3, a pair of second magnet portions 5G are included in place of the second magnet portion 5, and a complementary unit 9 is further included in comparison with the SERS unit 1. The handling plate 3G is formed of the same material as that of the handling plate 3 using the same scheme as that for the handling plate 3. The second magnet portions 5G are formed of the same material as that of the second magnet portion 5.

The handling plate 3G includes a main surface 31 and a back surface 32, and has a rectangular plate shape. A recessed portion 46 is formed in the main surface 31. The recessed portion 46 includes a bottom surface 46s and an inner surface (first surface) 46a. The recessed portion 46 is formed in a rectangular parallelepiped shape. A space S3 extending from the main surface 31 toward the back surface 32 is formed between the main surface 31 and the back surface 32. The space S3 is formed on both sides of the recessed portion 46 so that the recessed portion 46 is sandwiched along the main surface 31.

An outer edge of the space S3 on the recessed portion 46 side is defined by an inner surface (second surface) S3a. The inner surface S3a is a surface on an opposite side of the inner surface 46a of the recessed portion 46 (a surface that the inner surface S3a faces via a portion of the handling plate 3G). The inner surface 46a and the inner surface S3a extend substantially in parallel in a state in which the inner surfaces are spaced apart from each other. Thus, a portion 3a of the handling plate 3G is interposed between the inner surface 46a and the inner surface S3a.

The SERS element 2 is arranged in the recessed portion 46. More specifically, the SERS element 2 is accommodated in the recessed portion 46 so that the optical functional portion 10 is exposed from an opening portion of the recessed portion 46 toward the main surface 31 side. The SERS element 2 is arranged on the bottom surface 46s of the recessed portion 46 and on the inner surface 46a of the recessed portion 46 (along the inner surface 46a). A dimension (depth) of the recessed portion 46 is greater than a dimension (thickness) of the SERS element 2 in a thickness direction (a direction intersecting the main surface 31) of the handling plate 3G. Therefore, the entire SERS element 2 can be accommodated inside the recessed portion 46.

A sectional shape of the second magnet portion 5 is a triangular shape. The second magnet portions 5G are arranged in the spaces S3. More specifically, the second magnet portion 5G is accommodated inside the space S3 and arranged on the inner surface S3a. Accordingly, the SERS element 2 and the second magnet portion 5G are close to each other and face each other in a state in which a portion 3a of the handling plate 3G is interposed therebetween. Accordingly, in the SERS unit 1G the SERS element 2 is fixed to the handling plate 3G due to a magnetic force M between the first magnet portion 4 and the second magnet portion 5G in a state in which the SERS element 2 is spaced apart from the second magnet portion 5G.

Here, two complementary units 9 are arranged in each of the spaces S3. A sectional shape of the complementary unit 9 is an L shape. Focusing on a single space S3, the complementary units 9 are arranged on both sides of a partition plate 3c projecting into the space S3 in a state in which the complementary units 9 are opposite to each other. One end 9a of the complementary unit 9 is brought into contact with an inclined surface of the second magnet portion 5G, and the other end 9b of the complementary unit 9 projects from the space S3 and is held in a movable source U.

Thus, for example, if the movable source U arranged on the back surface 32 side is moved to the recessed portion 46 along the back surface 32 and the movable source U arranged on the main surface 31 side is moved to a side opposite to the recessed portion 46 along the main surface 31, each complementary unit 9 held in the movable source U is correspondingly moved. Thus, the second magnet portion 5G in contact with one end 9a of the complementary unit 9 is moved in a direction from the back surface 32 to the main surface 31 (a direction along the inner surface S3a). As a result, the SERS element 2 moves along the inner surface 46a of the recessed portion 46 to follow the movement of the second magnet portion 5G. That is, here, the SERS element 2 is movable along the inner surface 46a according to movement of the second magnet portion 5G along the inner surface S3a. It is preferable for a thickness of the second magnet portion 5G (a dimension in a direction from the back surface 32 to the main surface 31) to be equal to or less than the thickness of the SERS element 2. This is because a range of movement in a thickness direction of the second magnet portion 5G in the space S3 can be widened and, as a result, a range of movement of the SERS element 2 can be widened in a case where the thickness of the second magnet portion 5G is equal to or less than the thickness of the SERS element 2. Further, it is preferable for a range of movement of the SERS element 2 to be set so that the SERS element 2 is movable until the bottom surface of the SERS element 2 is brought into contact with the bottom surface 46s of the recessed portion 46. In this case, it is possible to correct inclination of the SERS element 2 with respect to the handling plate 3G by causing the bottom surface of the SERS element 2 to be brought into contact with the bottom surface 46s of the recessed portion 46.

According to such an SERS unit 1 it is possible to further achieve the following effects, in addition to the same effects as those of the SERS unit 1 described above. That is, in the SERS unit 1G, the SERS element 2 is movable along the inner surface 46a according to the movement of the second magnet portion 5G along the inner surface S3a. Therefore, according to the SERS unit 1G, the SERS element 2 can be easily arranged at a desired position.

In particular, according to the SERS unit 1 the position of the optical functional portion 10 of the SERS element 2 can be changed in a depth direction (a direction intersecting the main surface 31) of the recessed portion 46 by moving the second magnet portion 5G through driving of the complementary unit 9. That is, according to this SERS unit 1G, an alignment between a focus of an optical system of the measurement device such as the above-described Raman spectroscopic analysis device 50 and the optical functional portion 10 of the SERS element 2 can be performed in the handling plate 3G.

As a result, it becomes possible to realize compactness of the entire measurement system including a measurement device such as the Raman spectroscopic analysis device 50. In particular, according to the SERS unit 1Q a position of the movable source U or a degree of freedom of a direction of a force to be applied to the movable source U can be improved, for example, through adjustment of a shape of the complementary unit 9 or the like.

As illustrated in FIG. 11(b), an SERS unit (surface-enhanced Raman scattering unit) 1H is different from the handling plate 3 in that a handling plate (support member) 3H is included in place of the handling plate 3 and a pair of second magnet portions 5 are included in comparison with the SERS unit 1. The handling plate 3H is formed of the same material as that of the handling plate 3 using the same scheme as that for the handling plate 3.

The handling plate 3H includes a main surface 31 and a back surface 32, and has a rectangular plate shape. A recessed portion 46 is formed in the main surface 31. The recessed portion 46 includes a bottom surface 46s and an inner surface (first surface) 46a. Further, a space S4 is formed between the main surface 31 and the back surface 32. The space S4 is formed in a rectangular parallelepiped shape. The space S4 is formed on both sides of the recessed portion 46 so that the recessed portion 46 is sandwiched along the main surface 31. An edge portion on the recessed portion 46 side of the space S4 is defined by an inner surface (second surface) S4a. The inner surface S4a is a surface opposite to the inner surface 46a of the recessed portion 46 (a surface that the inner surface S4a faces via a portion of the handling plate 3H).

The inner surface 46a and the inner surface S4a extend substantially in parallel in a state in which the inner surfaces are spaced apart from each other. Thus, a portion 3a of the handling plate 3H is interposed between the inner surface 46a and the inner surface S4a. A communication hole 31h that communicates with the space S4 is formed in the main surface 31. Further, a communication hole 32h that communicates with the space S4 is formed in the back surface 32. Thus, in the communication hole 31h and the communication hole 32h, the space S4 is opened at the main surface 31 and the back surface 32.

The SERS element 2 is arranged in the recessed portion 46. More specifically, the SERS element 2 is accommodated in the recessed portion 46 so that the optical functional portion 10 is exposed from an opening portion of the recessed portion 46 to the main surface 31. The SERS element 2 is arranged on the bottom surface 46s of the recessed portion 46 and on the inner surface 46a of the recessed portion 46. In a thickness direction of the handling plate 3H (a direction intersecting the main surface 31), a dimension (depth) of the recessed portion 46 is greater than a dimension (thickness) of the SERS element 2. Therefore, the entire SERS element 2 can be accommodated inside the recessed portion 46.

The second magnet portions 5 are arranged in the spaces S4. More specifically, the second magnet portion 5 is accommodated inside the space S4 and arranged on the inner surface S4a of the space S4. Accordingly, the SERS element 2 and the second magnet portion 5 are close to each other and face each other in a state in which a portion 3a of the handling plate 3H is interposed between the SERS element 2 and the second magnet portion 5. Thus, in the SERS unit 1H, the SERS element 2 is fixed to the handling plate 3H due to a magnetic force M between the first magnet portion 4 and the second magnet portion 5 in a state in which the SERS element 2 is spaced apart from the second magnet portion 5.

Here, the second magnet portion 5 arranged in each space S4 is sandwiched by a movable source U inserted into the space S4 from the main surface 31 side through the communication hole 31h, and the movable source U inserted into the space S4 from the back surface 32 side through the communication hole 32h. Therefore, for example, if the movable source U is moved in a direction from the back surface 32 to the main surface 31 (a direction along the inner surface S4a), the second magnet portion 5 is also moved in the same direction. That is, the SERS element 2 is moved along the inner surface 46a to follow the movement of the second magnet portion 5.

According to such an SERS unit 1H, it is possible to further achieve the following effects, in addition to the same effects as those of the SERS unit 1 described above. That is, in the SERS unit 1H, the SERS element 2 is moved along the inner surface 46a according to the movement of the second magnet portion 5 along the inner surface S4a. Therefore, according to the SERS unit 1H, the SERS element 2 can be easily arranged at a desired position.

In particular, in the SERS unit 1H, by moving the second magnet portion 5 through driving of the movable source U, the SERS element 2 can be moved along the inner surface 46a to follow the movement of the second magnet portion 5 and the position of the optical functional portion 10 can be changed along a depth direction of the recessed portion 46 (a direction intersecting the main surface 31). That is, according to this SERS unit 1H, an alignment between a focus of an optical system of the measurement device such as the above-described Raman spectroscopic analysis device 50 and the optical functional portion 10 of the SERS element 2 can be performed using the second magnet portion 5 arranged in the handling plate 3H.

As a result, it is possible to realize compactness of the entire measurement system including a measurement device such as the Raman spectroscopic analysis device 50. In particular, according to the SERS unit 1H, a configuration for controlling the movement of the SERS element 2 is simplified.

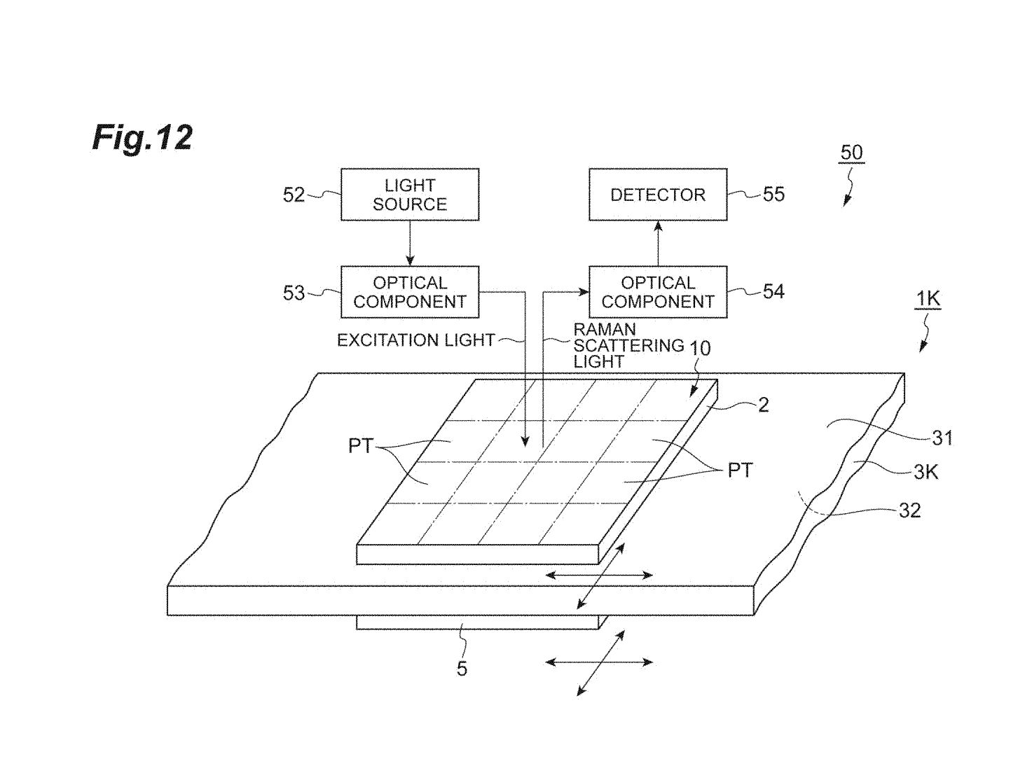

As illustrated in FIG. 12, the SERS unit (surface-enhanced Raman scattering unit) 1K includes, for example, a flat handling plate (support member) 3K, an SERS element 2 arranged on a main surface (first surface) 31 of the handling plate 3K, and a second magnet portion 5 arranged on a back surface (second surface) 32 of the handling plate 3K. In the SERS unit 1K, the SERS element 2 is two-dimensionally movable along the main surface 31 according to a two-dimensional movement along the back surface 32 of the second magnet portion 5.

Further, a plurality of patterns PT are provided in the optical functional portion 10 (according to the pattern of the fine structure portion 24). Here, the patterns PT are arranged two-dimensionally along the main surface 31. In such a case, it is necessary for the target pattern PT to be arranged at an irradiation position of the excitation light in order to selectively irradiate the target pattern PT with excitation light.

Therefore, for example, in the Raman spectroscopic analysis device 50, it is conceivable to move the entire SERS unit through the movement of the stage 51 on which the SERS unit is placed. However, in this case, a portion to be moved is in a wide range of the entire SERS unit and the stage 51. On the other hand, in the SERS unit 1K, the SERS element 2 may be moved along the main surface 31 by moving the second magnet portion 5. That is, a portion to be moved is limited to the SERS element 2 and the second magnet portion 5. As a result, it is possible to realize compactness of the measurement device such as the Raman spectroscopic analysis device 50.

Accordingly, it is possible to construct a measurement system in which the SERS element 2 in which an optimal pattern PT can be selected according to measurement molecules and a compact measurement device are combined. In other words, high sensitivity and high-precision surface-enhanced Raman measurement according to the measurement molecules can be realized by a compact system.

In the SERS unit illustrated in FIGS. 9 to 12, the SERS element is movable along the handling plate while being held in the handling plate due to the magnetic force. Accordingly, the SERS element being fixed to the handling plate due to the magnetic force includes at least a case in which the SERS element is maintained at a specific place of the handling plate due to a magnetic force, and a case in which the SERS element is temporarily held at the specific place of the handling plate by the magnetic force, and then, is moved without departing from the handling plate.

### Second Embodiment

A form in which the SERS element is fixed to the handling plate by magnetic force in a state in which the SERS element 2 is spaced apart from the second magnet portion has been described in the first embodiment. In the second embodiment, a form in which the SERS element is fixed to the handling plate by magnetic force in a state in which the SERS element is brought into contact with the second magnet portion will be described.

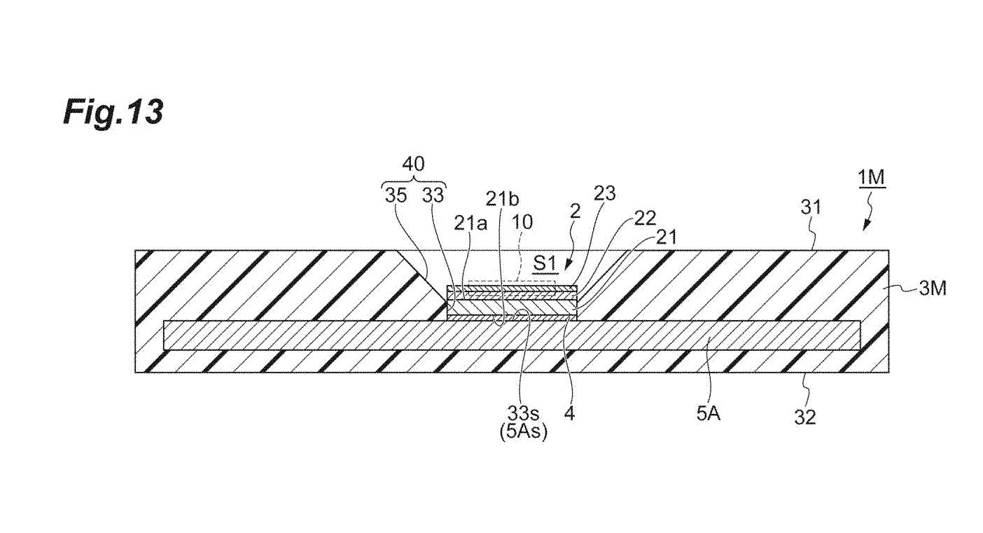

FIG. 13 is a cross-sectional view of a surface-enhanced Raman scattering unit according to the second embodiment. As illustrated in FIG. 13, the SERS unit (surface-enhanced Raman scattering unit) 1M is different from the SERS unit 1B according to a modification example of the first embodiment in that a handling plate (support member) 3M is included in place of the handling plate 3B. The handling plate 3M is formed of the same material as that of the handling plate 3 using the same scheme as that for the handling plate 3.

The handling plate 3M includes a main surface 31 and a back surface 32, and has a rectangular plate shape. A recessed portion 33 is formed in the main surface 31. More specifically, a recessed portion 35 is formed in the main surface 31, and a recessed portion 33 is formed in a bottom surface of the recessed portion 35. The recessed portion 33 and the recessed portion 35 are continuous to each other to constitute a single recessed portion 40. The recessed portion 40 is arranged substantially at a center in a longitudinal direction and a lateral direction of the handling plate 3M. Here, the bottom surface 33s of the recessed portion 33 is configured with a surface 5As of the second magnet portion 5A.

That is, the second magnet portion 5A is embedded in the handling plate 3M, and a portion of the surface 5As on the main surface 31 side is exposed at the main surface 31 side as the bottom surface 33s of the recessed portion 33. The second magnet portion 5A extends over substantially the entire handling plate 3M other than an outer edge of the handling plate 3M in a longitudinal direction of the handling plate 3M. The second magnet portion 5A is not exposed at the back surface 32 side.

The SERS element 2 is accommodated in the recessed portion 40 so that the first magnet portion 4 is brought into contact with the bottom surface 33s of the recessed portion 33 (that is, the surface 5As of the second magnet portion 5A). Therefore, in the SERS unit 1M, the SERS element 2 is fixed to the handling plate 3M due to a magnetic force M between the first magnet portion 4 and the second magnet portion 5 in a state in which the SERS element 2 is brought into contact with the second magnet portion 5A.

According to such an SERS unit 1M, it is possible to achieve the same effects as those of the SERS unit 1B according to the modification example of the first embodiment except for the effects of improvement of a degree of freedom of molding of the handling plate. Further, according to the SERS unit 1M, fixation strength is high since the first magnet portion 4 and the second magnet portion 5 are close to each other (here, are brought into contact with each other), unlike the SERS unit 1B according to the modification example of the first embodiment. Further, since the second magnet portion 5A is embedded in the handling plate 3M, it is possible to achieve compactness of the entire SERS unit 1M. Further, since most of the second magnet portion 5A is covered with the handling plate 3M, the second magnet portion 5A is prevented from rusting.

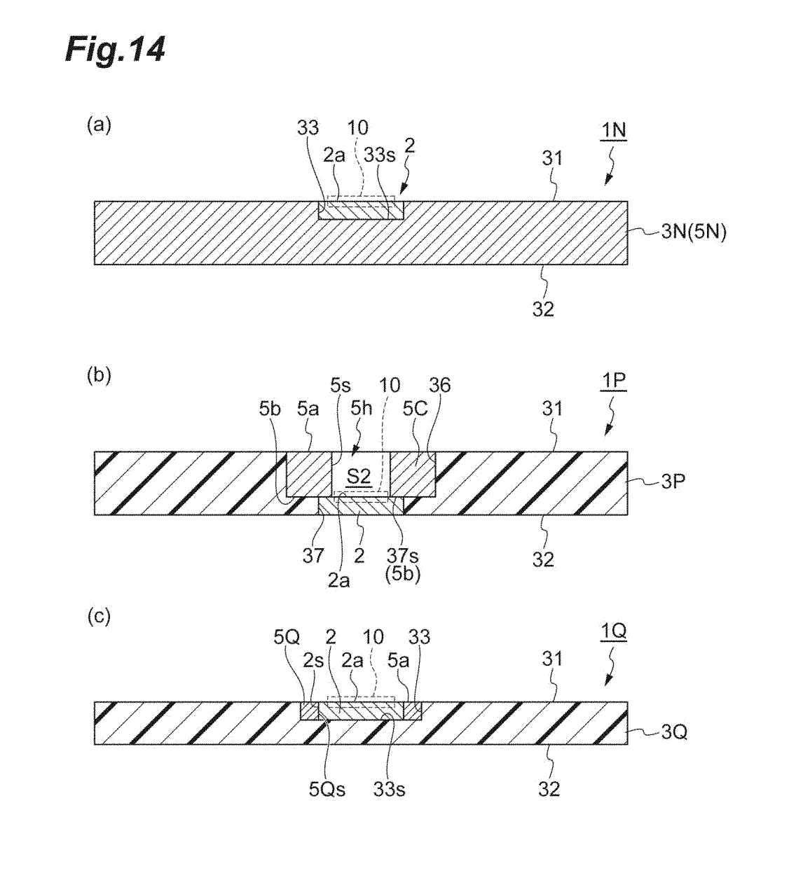

Subsequently, a modification example of the SERS unit 1M according to this embodiment will be described. FIG. 14 is a schematic cross-sectional view illustrating a modification example of the surface-enhanced Raman scattering unit illustrated in FIG. 13. As illustrated in FIG. 14(a), the SERS unit (surface-enhanced Raman scattering unit) 1N includes an SERS element 2, a handling plate (support member) 3N, a first magnet portion 4 (not illustrated), and a second magnet portion 5N.

The handling plate 3N includes a main surface 31 and a back surface 32, and has a rectangular plate shape. A recessed portion 33 is formed in the main surface 31. The handling plate 3N includes a permanent magnet (or temporary magnet). Alternatively, the handling plate 3N consists of a permanent magnet (or temporary magnet). Therefore, the handling plate 3N has a function of a second magnet portion 5N in addition to a function of a support member of the SERS element 2. In other words, the handling plate 3N is configured as a second magnet portion 5N. The second magnet portion 5N is formed of the same material as that of the second magnet portion 5.

The SERS element 2 is arranged in the recessed portion 33 of the main surface 31 of such a handling plate 3N (second magnet portion 5N). More specifically, the SERS element 2 is arranged so that the back surface 21b of the substrate 21 is on the bottom surface 33s side of the recessed portion 33. For example, the SERS element 2 is arranged on the bottom surface 33s of the recessed portion 33 so that the first magnet portion 4 is brought into contact with the bottom surface 33s of the recessed portion 33. Accordingly, in the SERS unit 1N, the SERS element 2 is fixed to the handling plate 3N due to a magnetic force M between the first magnet portion 4 and the second magnet portion 5N in a state in which the SERS element 2 is brought into contact with the second magnet portion 5N.

For example, a dimension (depth) of the recessed portion 33 is substantially the same as a dimension (thickness) of the SERS element 2 in a thickness direction of the handling plate 3N (a direction intersecting the main surface 31). Accordingly, the entire SERS element 2 is accommodated in the recessed portion 33 and a surface 2a (a surface on the main surface 21a side of the substrate 21) of the SERS element 2 is substantially flush with the main surface 31.

According to such an SERS unit 1N, it is possible to achieve the same effects as those of the SERS unit 1 according to the first embodiment. Further, according to the SERS unit 1N, fixation strength is high since the first magnet portion 4 and the second magnet portion 5N are close to each other (here, are brought into contact with each other), unlike the SERS unit 1 according to the first embodiment.

Further, in the SERS unit 1N, the handling plate 3N includes at least a permanent magnet (or temporary magnet). Therefore, there is less of an organic component compared to a handling plate formed of only a resin material. Therefore, it is possible to reduce the risk of thermal deformation or outgassing of the handling plate 3N. Further, the handling plate 3N has both of a function of a support member that supports the SERS element and a function of the second magnet portion 5N that generates a magnetic force M. Therefore, it is possible to realize convenience of member management or cost reduction by reducing the number of members.

As illustrated in FIG. 14(b), the SERS unit (surface-enhanced Raman scattering unit) 1P is different from the SERS unit 1C according to the modification example of the first embodiment in that a handling plate (support member) 3P is included in place of the handling plate 3C. The handling plate 3P is formed of the same material as that of the handling plate 3 using the same scheme as that for the handling plate 3. The handling plate 3P includes a main surface 31 and a back surface 32, and has a rectangular plate shape.

A recessed portion 36 is formed in the main surface 31. Further, a recessed portion 37 is formed in the back surface 32. However, a bottom surface 37s of the recessed portion 37 is configured with a back surface 5b of the second magnet portion 5C. The SERS element 2 is arranged in the recessed portion 37. More specifically, the SERS element 2 is arranged on the bottom surface 37s so that an outer edge of a surface 2a (a surface of the optical functional portion 10) of the SERS element 2 is brought into contact with the bottom surface 37s of the recessed portion 37 (that is, the back surface 5b of the second magnet portion 5C). Accordingly, in the SERS unit 1P, the SERS element 2 is fixed to the handling plate 3P due to a magnetic force M between the first magnet portion 4 and the second magnet portion 5C in a state in which the SERS element 2 is brought into contact with the second magnet portion 5C.

According to such an SERS unit 1P, it is possible to achieve the same effects as those of the SERS unit 1C according to the modification example of the first embodiment. Further, according to the SERS unit 1P, fixation strength is high since the first magnet portion 4 and the second magnet portion 5C are close to each other, in comparison with the SERS unit 1C. Further, since a portion of the handling plate is not interposed between the SERS element 2 and the second magnet portion 5C, the entirety is correspondingly thinned in comparison with the SERS unit 1C.

As illustrated in FIG. 14 (c), the SERS unit (surface-enhanced Raman scattering unit) 1Q is different from the SERS unit 1 according to the first embodiment in that a handling plate (support member) 3Q is included in place of the handling plate 3, and a second magnet portion 5Q is included in place of the second magnet portion 5 in comparison with the SERS unit 1. The handling plate 3Q is formed of the same material as that of the handling plate 3 using the same scheme as that for the handling plate 3. Further, the second magnet portion 5Q is formed of the same material as that of the second magnet portion 5.

The handling plate 3Q includes a main surface 31 and a back surface 32, and has a rectangular plate shape. A recessed portion 33 is provided in the main surface 31. The SERS element 2 is arranged in the recessed portion 33. More specifically, the SERS element 2 is arranged so that the back surface 21b of the substrate 21 is on the bottom surface 33s side of the recessed portion 33. For example, the SERS element 2 is arranged on the bottom surface 33s of the recessed portion 33 so that the first magnet portion 4 is brought into contact with the bottom surface 33s of the recessed portion 33.

Further, the second magnet portion 5Q is also arranged in the recessed portion 33, similar to the SERS element 2. More specifically, the second magnet portion 5Q has, for example, a rectangular annular shape. The second magnet portion 5Q is accommodated in the recessed portion 33 so that the SERS element 2 is arranged between inner surfaces 5Qs that face each other. In other words, the second magnet portion 5Q is arranged in the recessed portion 33 to surround the SERS element 2, for example, when viewed from a thickness direction (a direction intersecting the main surface 31) of the handling plate 3Q. That is, the SERS element 2 and the second magnet portion 5Q are arranged along the main surface 31 in the recessed portion 33. At least one of the side surfaces 2s of the SERS element 2 is brought into contact with the inner surface 5Qs of the second magnet portion 5Q that faces the side surface 2s.

Accordingly, in the SERS unit 1Q, the SERS element 2 is fixed to the handling plate 3Q due to a magnetic force M between the first magnet portion 4 and the second magnet portion 5Q in a state in which the SERS element 2 is brought into contact with the second magnet portion 5Q.

For example, in a thickness direction of the handling plate 3Q, a dimension (thickness) of the SERS element 2 and the second magnet portion 5Q is substantially the same as a dimension (depth) of the recessed portion 33. Thus, the entire SERS element 2 and the second entire magnet portion 5Q are accommodated in the recessed portion 33, and a surface (a surface on the main surface 21a side of the substrate 21) 2a of the SERS element 2 and a surface 5a of the second magnet portion 5Q are substantially flush with the main surface 31.

According to such an SERS unit 1Q, it is possible to achieve the same effects as those of the SERS unit 1 according to the first embodiment. Further, according to the SERS unit 1Q, since the first magnet portion 4 and the second magnet portion 5Q are close to each other (for example, are brought into contact with each other), fixation strength is high. Further, the SERS element 2 and the second magnet portion 5Q have substantially the same thickness, and, the SERS element 2 and the second magnet portion 5 are arranged along the main surface 31. Therefore, the thickness of the handling plate 3Q is reduced and the overall SERS unit 1Q is thinned. Thus, portability of the SERS unit 1Q is enhanced.

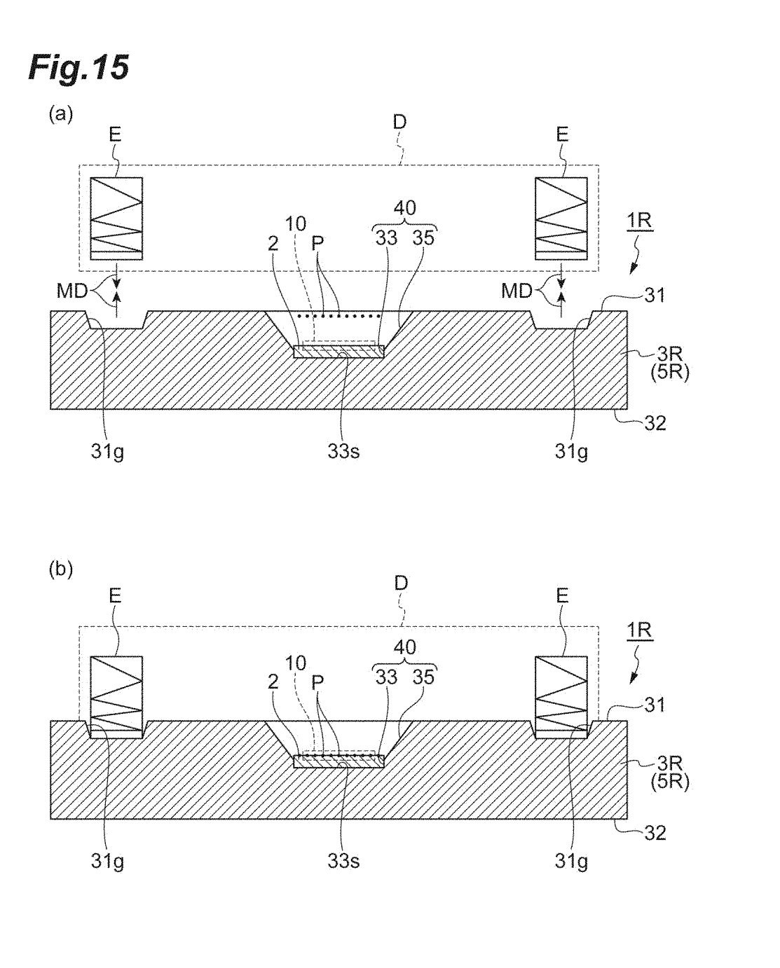

FIG. 15 is a schematic cross-sectional view illustrating a modification example of the surface-enhanced Raman scattering unit illustrated in FIG. 13. As illustrated in FIG. 15, an SERS unit (surface-enhanced Raman scattering unit). 1R is different from the SERS unit 1M illustrated in FIG. 13 in that a handling plate (support member) 3R is included in place of the handling plate 3M, and a second magnet portion 5R is included in place of the second magnet portion 5.

The handling plate 3R includes a main surface 31 and a back surface 32, and has a rectangular plate shape. A recessed portion 33 and a recessed portion 35 are formed in the main surface 31, and a recessed portion 40 is configured with the recessed portion 33 and the recessed portion 35. The handling plate 3R includes a permanent magnet (or temporary magnet). Alternatively, the handling plate 3R consists of a permanent magnet (or temporary magnet). Therefore, the handling plate 3R has a function of the second magnet portion 5R, in addition to a function of a support member of the SERS element 2. In other words, the handling plate 3R is configured as the second magnet portion 5R. The second magnet portion 5R is formed of the same material as that of the second magnet portion 5.

The SERS element 2 is arranged in the recessed portion 33 of such a handling plate 3R (second magnet portion 5R). More specifically, the SERS element 2 is arranged so that the back surface 21b of the substrate 21 is on the bottom surface 33s side of the recessed portion 33. For example, the SERS element 2 is arranged on the bottom surface 33s of the recessed portion 33 so that the first magnet portion 4 is brought into contact with the bottom surface 33s of the recessed portion 33. Accordingly, in the SERS unit 1R, the SERS element 2 is fixed to the handling plate 3R due to a magnetic force M between the first magnet portion 4 and the second magnet portion 5R in a state in which the SERS element 2 is brought into contact with the second magnet portion 5R.

According to such an SERS unit 1R, it is possible to achieve the same effects as those of the SERS unit 1B except for the effect of the second magnet portion 5A extending over substantially the entire back surface 32 of the handling plate 3B. Further, according to the SERS unit 1R, since the first magnet portion 4 and the second magnet portion 5R are close to each other (for example, are brought into contact with each other), fixation strength is high. Further, according to the SERS unit 1R, it is possible to achieve the following effects. That is, for example, if an electromagnet E is provided in a measurement device D such as the above-described Raman spectroscopic analysis device 50, the measurement device D and the SERS unit 1R can attract each other due to a magnetic force MD between the handling plate 3R as the second magnet portion 5R and the electromagnet E. Accordingly, for example, when the measurement device D approaches the SERS unit 1R until the electromagnet E is brought into contact with the main surface 31 (a bottom surface of a guide groove 31g to be described below), alignment can be automatically performed so that a focal point P of an optical system of the measurement device D coincides with the optical functional portion 10 of the SERS element 2.

Further, in the SERS unit 1R, if the guide groove 31g for the electromagnet E is provided at an appropriate position of the main surface 31 of the handling plate 3R (for example, a position overlapping the electromagnet E when viewed from a direction intersecting with the main surface 31), the electromagnet E enters the guide groove 31g while being guided by the inner surface of the guide groove 31g. Thus, it is possible to reliably align the arrangement of the SERS unit 1R in a direction along the main surface 31 of the handling plate 3R.

### Third Embodiment

A form in which the first magnet portion is provided in the SERS element (for example, a form in which the SERS element includes the first magnet portion) has been described in the first embodiment and the second embodiment. In the third embodiment, a form in which the first magnet portion is provided separately from the SERS element will be described.

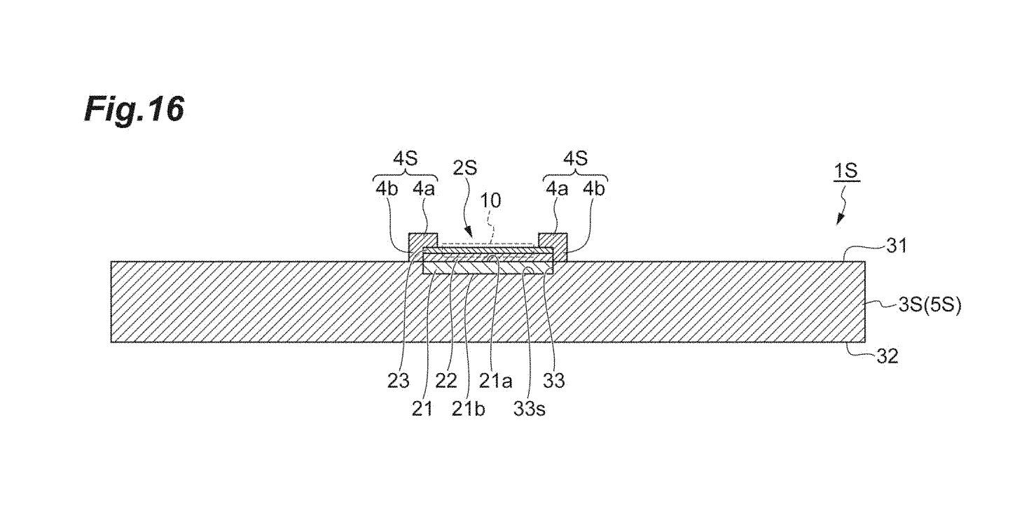

FIG. 16 is a cross-sectional view of a surface-enhanced Raman scattering unit according to the third embodiment. As illustrated in FIG. 16, an SERS unit (surface-enhanced Raman scattering unit) according to this embodiment 1S includes an SERS element (surface-enhanced Raman scattering element) 2S, a handling plate (support member) 3S, a first magnet unit 4S, and a second magnet portion 5S. The SERS element 2S is different from the SERS element 2 in that the first magnet portion 4 is not provided (that is, the first magnet portion 4 is not included). Other configurations of the SERS element 2S are the same as those of the SERS element 2. Thus, the SERS element 2S includes an optical functional portion 10.

The handling plate 3S includes a main surface 31 and a back surface 32, and has a rectangular plate shape. A recessed portion 33 is formed in the main surface 31. The handling plate 3S includes a permanent magnet (or temporary magnet). Alternatively, the handling plate 3S consists of a permanent magnet (or temporary magnet). Therefore, the handling plate 3S has a function of a second magnet portion 5S, in addition to a function of a support member for the SERS element 2S. In other words, the handling plate 3S is configured as the second magnet portion 5S. The second magnet portion 5S is formed of the same material as that of the second magnet portion 5.

The SERS element 2S is arranged in the recessed portion 33 of the main surface 31 of such a handling plate 3S (second magnet portion 5S). More specifically, the SERS element 2S is arranged so that the back surface 21b of the substrate 21 is on the bottom surface 33s side of the recessed portion 33. For example, the SERS element 2S is arranged on the bottom surface 33s so that the back surface 21b of the substrate 21 is brought into contact with the bottom surface 33s of the recessed portion 33. Here, a portion of the SERS element 2S is accommodated in the recessed portion 33 in a thickness direction of the handling plate 3 and the other portion of the SERS element 2S projects from the recessed portion 33.

The first magnet portion 4S is formed, for example, in a rectangular annular shape. The first magnet portion 4S includes a first portion 4a that is arranged on an outer edge of a surface (a surface on the main surface 21a side of the substrate 21) 2a of the SERS element 2S, and a second portion 4b that extends from the first portion 4a to the main surface 31 of the handling plate 3S and is brought into contact with the main surface 31. The first magnet portion 4S is attracted to the main surface 31 due to a magnetic force M between the first magnet portion 4S and the second magnet portion 5S. Therefore, the first portion 4a of the first magnet portion 4S is brought into contact with the outer edge of the surface 2a of the SERS element 2S to press the SERS element 2S to the bottom surface 33s of the recessed portion 33. Thus, the SERS element 2S is fixed to the handling plate 3S.

That is, in the SERS unit 1S, the SERS element 2S is fixed to the handling plate 3S due to a magnetic force M between the first magnet portion 4S and the second magnet portion 5S. In particular, in the SERS unit 1S, the SERS element 2S is fixed to the handling plate 3S in a state in which the SERS element 2S is sandwiched between the first magnet portion 4S (first portion 4a) and the second magnet portion 5S. In this state, the optical functional portion 10 of the SERS element 2S is exposed from between the facing first portions 4a of the first magnet portion 4S.

According to such an SERS unit 1S, it is possible to achieve the same effects as those of the SERS unit 1 according to the first embodiment except for an effect in which an area for the optical functional portion 10 can be secured over a wide range. Further, according to the SERS unit 1S, since it is not necessary for the first magnet portion 4S to be provided in the SERS element 2S (to be included in the SERS element 2S), a process of manufacturing the SERS element 2S and the SERS unit 1S is simplified.

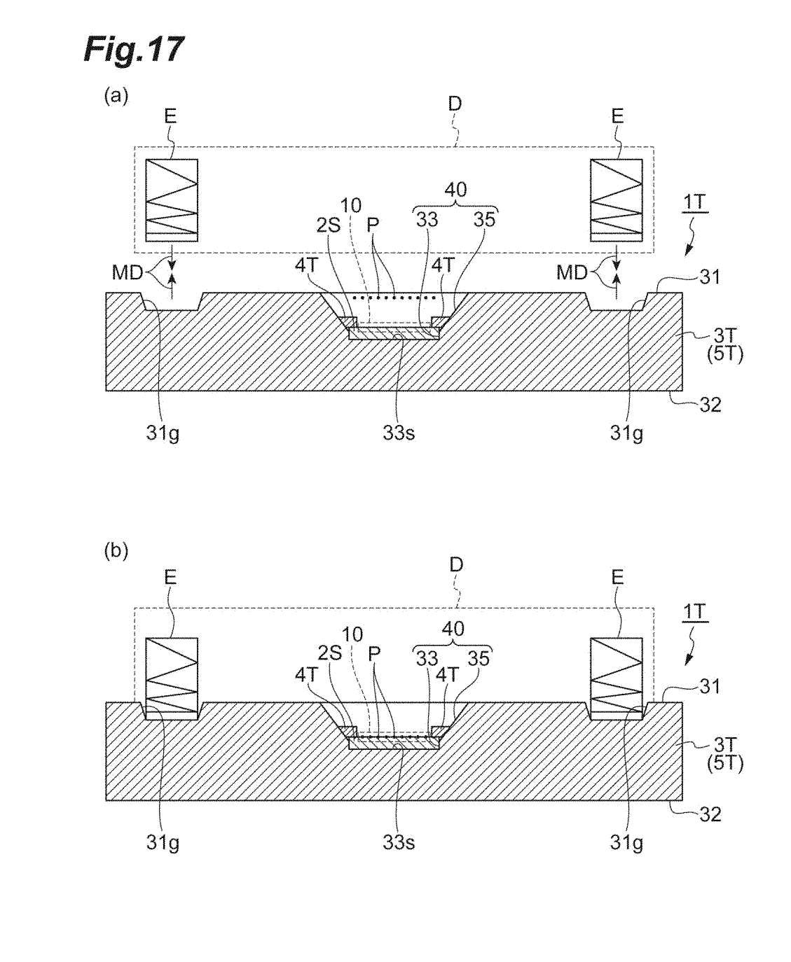

FIG. 17 is a schematic cross-sectional view illustrating a modification example of the surface-enhanced Raman scattering unit illustrated in FIG. 16. As illustrated in FIG. 16, an SERS unit (surface-enhanced Raman scattering unit) 1T is different from the SERS unit 1S illustrated in FIG. 16 in that a handling plate (support member) 3T is included in place of the handling plate 3S, a first magnet portion 4T is included in place of the first magnet portion 4S, and a second magnet portion 5T is included in place of the second magnet portion 5S.

The handling plate 3T includes a main surface 31 and a back surface 32, and has a rectangular plate shape. A recessed portion 33 and a recessed portion 35 are formed in the main surface 31, and recessed portion 40 is configured with the recessed portion 33 and the recessed portion 35. The handling plate 3T includes a permanent magnet (or temporary magnet). Alternatively, the handling plate 3T consists of a permanent magnet (or temporary magnet). Therefore, the handling plate 3T has a function of the second magnet portion 5T, in addition to a function of a support member for the SERS element 2S. In other words, the handling plate 3T is configured as the second magnet portion 5T. The second magnet portion 5T is formed of the same material as that of the second magnet portion 5.

The SERS element 2S is arranged in the recessed portion 33 of such a handling plate 3T (second magnet portion 5S). More specifically, the SERS element 2S is arranged so that the back surface 21b of the substrate 21 is on the bottom surface 33s side of the recessed portion 33. For example, the SERS element 2S is arranged on the bottom surface 33s so that the back surface 21b of the substrate 21 is brought into contact with the bottom surface 33s of the recessed portion 33. Here, the entire SERS element 2S is accommodated in the recessed portion 40.

The first magnet portion 4T is formed, for example, in a rectangular annular shape. The first magnet portion 4T is arranged in the recessed portion 40. Here, the first entire magnet portion 4T is accommodated in the recessed portion 40. The first magnet portion 4T is arranged on an outer edge of a surface (a surface on the main surface 21a side of the substrate 21) 2a of the SERS element 2S. The first magnet portion 4T is attracted to the bottom surface 33s of the recessed portion 33 due to a magnetic force M between the first magnet portion 4T and the second magnet portion 5T. Therefore, the first magnet portion 4T is brought into contact with the outer edge of the surface 2a of the SERS element 2S to press the SERS element 2S to the bottom surface 33s of the recessed portion 33. Thus, the SERS element 2S is fixed to the handling plate 3T.

That is, in the SERS unit 1T, the SERS element 2S is fixed to the handling plate 3T due to the magnetic force between the first magnet portion 4T and the second magnet portion 5T. In particular, in the SERS unit 1T, the SERS element 2S is fixed to the handling plate 3T in a state in which the SERS element 2S is sandwiched between the first magnet portion 4T and the second magnet portion 5T. In this state, the optical functional portion 10 of the SERS element 2S is exposed from between the facing portions of the first magnet portion 4T.

According to such an SERS unit 1T, it is possible to achieve the same effects as those of the SERS unit 1S. Further, according to the SERS unit 1T, it is possible to achieve the following effects, similar to the SERS unit 1R. That is, a measurement device D and the SERS unit 1T can attract each other due to a magnetic force MD between the handling plate 3T as the second magnet portion 5T and an electromagnet E of the measurement device D. Accordingly, for example, when the measurement device D approaches the SERS unit 1T until the electromagnet E is brought into contact with the main surface 31 (a bottom surface of a guide groove 31g), alignment can be automatically performed so that a focal point P of an optical system of the measurement device D coincides with the optical functional portion 10 of the SERS element 2S.

Further, in the SERS unit 1T, if the guide groove 31g for the electromagnet E is provided at an appropriate position of the main surface 31 of the handling plate 3T (for example, a position overlapping the electromagnet E when viewed from a direction intersecting with the main surface 31), the electromagnet E enters the guide groove 31g while being guided by the inner surface of the guide groove 31g. Thus, it is possible to reliably align the arrangement of the SERS unit 1T in a direction along the main surface 31 of the handling plate 3T.

In this embodiment, the case in which the handling plate is configured as the second magnet portion has been described. However, a second magnet portion configured separately from the handling plate may be held in the handling plate. In this case, a portion of the handling plate or the like may be interposed between the SERS element and the second magnet portion. That is, the first magnet portion and the second magnet portion can be fixed to the handling plate while the SERS element is sandwiched therebetween in a state in which another element (for example a portion of the handling plate) other than the SERS element is sandwiched between the first magnet portion and the second magnet portion. In other words, when the SERS element is sandwiched by the first magnet portion and the second magnet portion, the first magnet portion and the second magnet portion may not be brought into contact with the SERS element.

### [Modification Example of SERS Element]

Subsequently, a modification example of the SERS element to be applied to the SERS unit according to the above embodiment will be described.

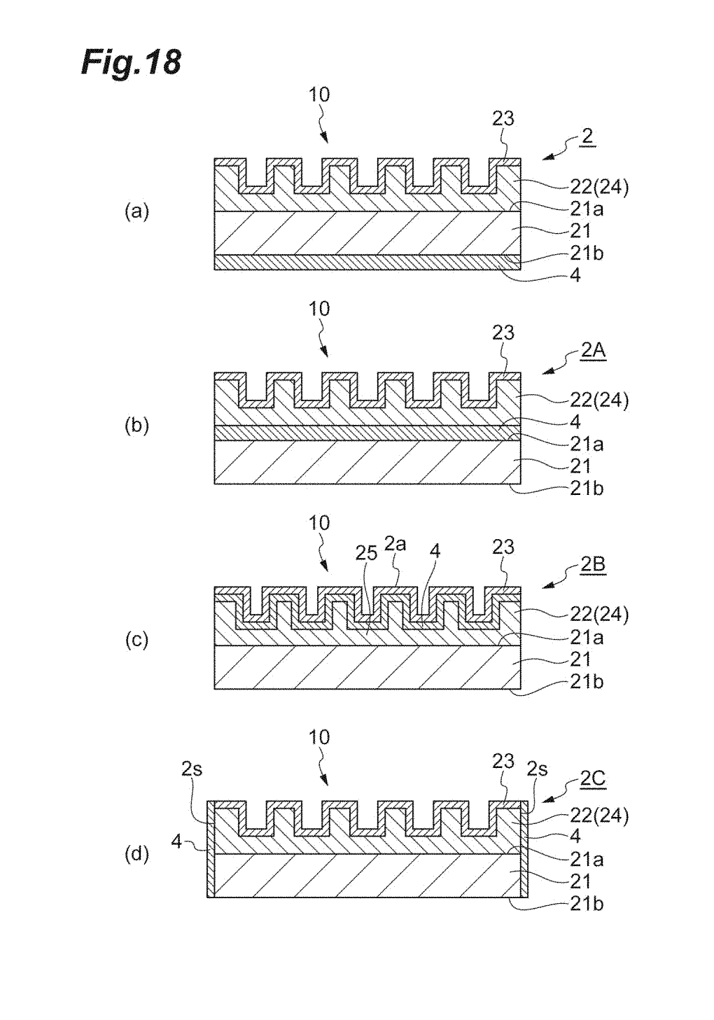

FIGS. 18 to 20 are schematic cross-sectional views illustrating a modification example of the surface-enhanced Raman scattering element illustrated in FIG. 2. FIG. 18(a) illustrates the SERS element 2 described above. In the SERS element 2, as described above, a first magnet portion 4 is provided on a back surface 21b of a substrate 21. Therefore, in the SERS element 2, when the second magnet portion 5 is arranged on the back surface 21b side of the substrate 21, the second magnet portion 5 and the first magnet portions 4 can be caused to be close to each other (or brought into contact with each other), and fixing of the SERS element 2 can be strengthened.

As illustrated in FIG. 18(b), an SERS element (surface-enhanced Raman scattering element) 2A includes a substrate 21, a molded layer 22 (fine structure portion 24), a conductor layer 23, and a first magnet portion 4, similar to the SERS element 2. Further, the SERS element 2A includes an optical functional portion 10. However, in the SERS element 2A, the first magnet portion 4 is provided between a main surface 21a of the substrate 21 and the molded layer 22 (fine structure portion 24). The first magnet portion 4 is formed as a film.

According to the SERS element 2A, the first magnet portion 4 can be used as a reflective layer of excitation light. Further, for example, the surface of the first magnet portion 4 formed through vapor deposition or the like may be coarser than the main surface 21a of the substrate 21 formed of silicon. Therefore, according to the SERS element 2A, the molded layer 22 (fine structure portion 24) and the first magnet portion 4 can be firmly bonded by a zipper effect (fastener effect).

As illustrated in FIG. 18(c), an SERS element (surface-enhanced Raman scattering element) 2B includes a substrate 21, a molded layer 22 (fine structure portion 24), a conductor layer 23, and a first magnet portion 4, similar to the SERS element 2. Further, the SERS element 2B includes an optical functional portion 10. However, in the SERS element 2B, the first magnet portion 4 is provided between the molded layer 22 (fine structure portion 24) and the conductor layer 23. Here, for example, the first magnet portion 4 is provided on a surface of each pillar of the fine structure portion 24 and a surface of a support portion 25 exposed at the opposite side of the substrate 21 (that is, the first magnet portion 4 is provided to cover the entire molded layer 22).

According to the SERS element 2B, it is possible to efficiently use the first magnet portion 4 as a reflective layer of excitation light. Further, in the SERS element 2B, since the first magnet portion 4 is arranged to be close to the surface (a surface on the main surface 21a side of the substrate 21) 2a of the SERS element 2B, the first magnet portion 4 and the second magnet portion 5 can be caused to be relatively close to each other and fixing of the SERS element 2B can be strengthened in a case in which the second magnet portion 5 is arranged on the main surface 21a side of the substrate 21.

As illustrated in FIG. 18(d), an SERS element (surface-enhanced Raman scattering element) 2C includes a substrate 21, a molded layer 22 (fine structure portion 24), a conductor layer 23, and a first magnet portion 4, similar to the SERS element 2. Further, the SERS element 2C includes an optical functional portion 10. However, in the SERS element 2C, the first magnet portion 4 is provided on side surfaces 2s of the SERS element 2. A side surface 2s of the SERS element 2 includes a side surface of the substrate 21, a side surface of the molded layer 22, and a side surface of the conductor layer 23, and is a surface extending from the substrate 21 to the conductor layer 23 in a direction intersecting a main surface 21a of the substrate 21.

In this SERS element 2C, in a case in which the second magnet portion 5 is arranged on the side surface 2s side of the SERS element 2C, the first magnet portion 4 and the second magnet portion 5 can be caused to be close to each other (or to be brought into contact with each other), and fixing of the SERS element 2C can be strengthened. Therefore, when the SERS element 2C is fixed to the handling plate 3, it is not necessary for the first magnet portion 4 and the second magnet portion 5 to be arranged in a thickness direction of the SERS unit 1. Thus, it is possible to reduce a thickness of the SERS unit 1. Further, in a case in which the second magnet portion 5 is moved in the thickness direction of the handling plate (for example, the handling plate 3G or 3H), the ability of the SERS element 2C to follow is improved and the SERS element 2C is easily arranged at a desired position.

As in the SERS elements 2 to 2C, the first magnet portion 4 can be provided in various places of the SERS element. Further, the first magnet portion 4 may be simultaneously provided at a plurality of positions of the SERS element. That is, the first magnet portion 4 may be provided at least on the back surface 21b, between the main surface 21a and the fine structure portion 24 (molded layer 22), between the fine structure portion 24 (molded layer 22) and the conductor layer 23, or on the side surface 2s of the SERS element extending in a direction intersecting the main surface 21a.

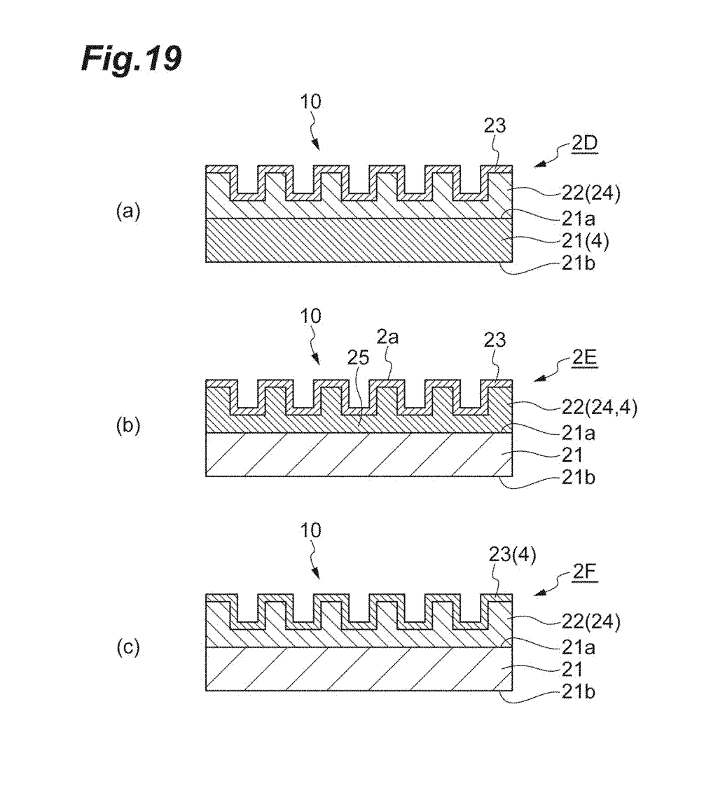

As illustrated in FIG. 19(a), an SERS element (surface-enhanced Raman scattering element) 2D includes a substrate 21, a molded layer 22 (fine structure portion 24), a conductor layer 23, and a first magnet portion 4, similar to the SERS element 2. Further, the SERS element 2D includes an optical functional portion 10. However, in the SERS element 2D, the substrate 21 is configured with a temporary magnet (or permanent magnet). Alternatively, in the SERS element 2D, the substrate 21 includes a temporary magnet (or permanent magnet). That is, in the SERS element 2D, the substrate 21 is configured as the first magnet portion 4. According to this SERS element 2D, the SERS element 2D can be miniaturized (thinned) and cost can be reduced due to a reduction in the number of members in comparison with a case in which the first magnet portion 4 is provided separately from the substrate 21.

Further, in the SERS element 2D, in a case in which the second magnet portion 5 is arranged on a back surface 21b side of the substrate 21, the first magnet portion 4 and the second magnet portion 5 can be caused to be close to each other (or brought into contact with each other), and fixing of the SERS element 2D can be strengthened, as in the SERS element 2. Further, in the SERS element 2D, the substrate 21 can be used as a reflective layer of excitation light, as in the SERS element 2A. Further, in the SERS element 2D, the substrate 21 and the molded layer 22 (fine structure portion 24) can be firmly bonded by a zipper effect (fastener effect), as in the SERS element 2A.

In particular, in the SERS element 2D, if the substrate 21 as the first magnet portion 4 is configured as a flexible film, a roll-to-roll scheme can be used in the manufacture of the SERS element 2D, and productivity can be improved. Further, if the substrate 21 is configured as a flexible film, the ability to follow with respect to irregularities of the handling plate 3 to which the SERS element 2D is fixed increases. Accordingly, even when a fixing surface (contact surface) for the SERS element 2D in the handling plate 3 is a curved surface, the SERS element 2D can be fixed. Further, by deforming the SERS element 2D to follow the curved fixing surface (contact surface) of the handling plate 3, the strength of surface-enhanced Raman scattering can be adjusted through deformation of a periodic pattern of the fine structure portion 24.

As illustrated in FIG. 19(b), an SERS element (surface-enhanced Raman scattering element) 2E includes a substrate 21, a molded layer 22 (fine structure portion 24), a conductor layer 23, and a first magnet portion 4, similar to the SERS element 2. Further, the SERS element 2E includes an optical functional portion 10. However, in the SERS element 2E, the molded layer 22 (fine structure portion 24) is configured with a temporary magnet (or permanent magnet). Alternatively, in the SERS element 2E, the molded layer 22 (fine structure portion 24) includes a temporary magnet (or permanent magnet). That is, in the SERS element 2E, the molded layer 22 (fine structure portion 24) is configured as a first magnet portion 4.

According to the SERS element 2E, the molded layer 22 (fine structure portion 24) can be efficiently used as a reflective layer of the excitation light, as in the SERS element 2B. Further, in the SERS element 2E, since the first magnet portion 4 is arranged to be close to a surface (a surface on the main surface 21a side of the substrate 21) 2a of the SERS element 2E, the first magnet portion 4 and the second magnet portion 5 can be caused to be relatively close to each other and fixing of the SERS element 2E can be strengthened when the second magnet portion 5 is arranged on the surface 21a side of the main substrate 21, as in the SERS element 2B.

Further, in the SERS element 2E, a thermal expansion coefficient difference between the molded layer 22 and the substrate 21 can be reduced in comparison with a case in which the molded layer 22 is configured with a resin or a low melting point glass. A material with a small thermal expansion coefficient difference with respect to the substrate 21 is selected as a temporary magnet (or permanent magnet) constituting the molded layer 22 or a raw material of the temporary magnet (or permanent magnet) included in the molded layer 22 functions as a filler that reduces a thermal expansion coefficient difference between the material of the molded layer 22 (for example, a resin or a low melting point glass) and a material of the substrate 21 to obtain effects thereof. Thus, it is possible to reduce the risk of delamination between the molded layer 22 and the substrate 21 according to a thermal stress.

As illustrated in FIG. 19(c), an SERS element (surface-enhanced Raman scattering element) 2F includes a substrate 21, a molded layer 22 (fine structure portion 24), a conductor layer 23, and a first magnet portion 4, similar to the SERS element 2. Further, the SERS element 2F includes an optical functional portion 10. However, in the SERS element 2F, the conductor layer 23 is configured with a temporary magnet (or permanent magnet). Alternatively, in the SERS element 2F, the conductor layer 23 includes a temporary magnet (or permanent magnet). That is, in the SERS element 2F, the conductor layer 23 is configured as the first magnet portion 4.

According to the SERS element 2F, in a case in which the second magnet portion 5 is arranged on the main surface 21a side of the substrate 21, the first magnet portion 4 and the second magnet portion 5 can be caused to be close to each other (or brought into contact with each other), and fixing of the SERS element 2F can be strengthened. Further, the conductor layer 23 and the first magnet portion 4 are formed using a single process. Therefore, it is possible to reduce the number of processes in the manufacture of the SERS element 2F and reduce cost.

As in the SERS elements 2D to 2F, each member of the SERS element can be configured as the first magnet portion 4. Further, a plurality of members of the SERS element may be configured as the first magnet portion 4. That is, at least one of the substrate 21, the molded layer 22 (fine structure portion 24), and the conductor layer 23 can be configured as the first magnet portion 4.

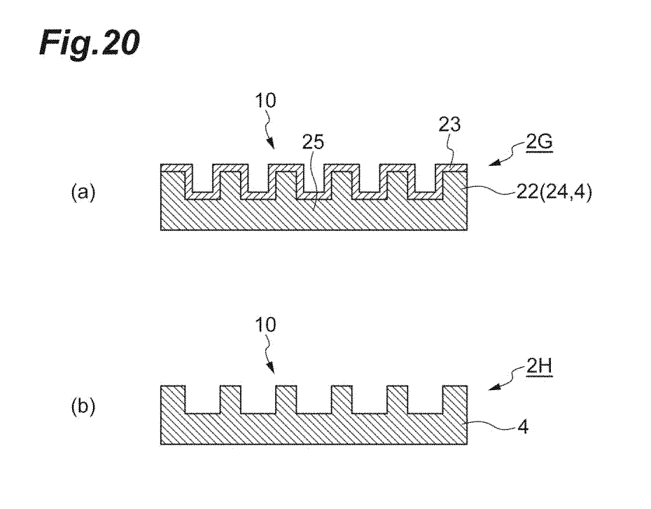

As illustrated in FIG. 20(a), an SERS element (surface-enhanced Raman scattering element) 2G includes a molded layer 22 (fine structure portion 24), a conductor layer 23, and a first magnet portion 4. Further, the SERS element 2G includes an optical functional portion 10. However, the SERS element 2G does not include the substrate 21, unlike the SERS elements 2 to 2F. Further, in the SERS element 2Q the molded layer 22 (fine structure portion 24) is configured with a temporary magnet (or permanent magnet), as in the SERS element 2E. Alternatively, in the SERS element 2G the molded layer 22 (fine structure portion 24) includes a temporary magnet (or permanent magnet). That is, in the SERS element 2Q the molded layer 22 (fine structure portion 24) is configured as the first magnet portion 4. According to the SERS element 2G, the first magnet portion 4 can be efficiently used as a reflective layer of excitation light, as in the SERS elements 2B and 2E.

In particular, in the SERS element 2Q if the molded layer 22 as the first magnet portion 4 is configured as a flexible film, a roll-to-roll scheme can be used in the manufacture of the SERS element 2G, and productivity is improved. Further, if the molded layer 22 is configured as a flexible film, the ability to follow with respect to irregularities of the handling plate 3 to which the SERS element 2G is fixed increases. Accordingly, even when a fixing surface (contact surface) for the SERS element 2G in the handling plate 3 is a curved surface, the SERS element 2G can be fixed. Further, by deforming the SERS element 2G to follow the curved fixing surface (contact surface) of the handling plate 3, the strength of surface-enhanced Raman scattering can be adjusted through deformation of a periodic pattern of the fine structure portion 24.

Further, the SERS element 2G is formed only of a molded layer 22 (fine structure portion 24) as the first magnet portion 4, and a conductor layer 23. Therefore, since the number of members is smaller than in the form in which the substrate 21 is included, it is possible to realize an improvement in convenience of member management and cost reduction. Further, it is possible to thin the entire SERS element 2G in comparison with that in the form in which the substrate 21 is included, for the same reason, and as a result, it is possible to realize compactness of the SERS unit 1. Further, for the same reason, for example, when each SERS element 2G is made into a chip from a base material on which a plurality of SERS elements 2G are formed en bloc, it is possible to reduce the risk of damage of a chip end surface in comparison with the form in which the substrate 21 is included.

As illustrated in FIG. 20(b), the SERS element 2H is formed of only the first magnet portion 4. The first magnet portion 4 has the same configuration as the molded layer 22 and the conductor layer 23. That is, the first magnet portion 4 includes a fine structure portion 24 to constitute the optical functional portion 10. Thus, if the SERS elements 2H is configured with a single member, it is possible to realize an improvement in convenience of member management and cost reduction. Further, since the SERS elements 2H can be formed of a single material, the SERS elements 2H can be manufactured through a small number of processes.

The SERS element may be appropriately selected according to the form of the SERS unit. For example, the SERS units 1, 1A, 1B, 1D, 1E, 1F, and 1K according to the first embodiment, and the SERS units 1M, 1 N, and 1R according to the second embodiment are in the form in which the second magnet portion is arranged on the back surface side of the substrate of the SERS element (on the opposite side of the optical functional portion). Therefore, in the SERS units, if the SERS element 2, 2D, 2G or 2H is used, relatively strong fixing can be realized.

Further, the SERS unit 1C according to the first embodiment and the SERS unit 1P according to the second embodiment are in the form in which the second magnet portion is arranged on the main surface side (optical functional portion side) of the substrate of the SERS element. Therefore, in the SERS units, if the SERS element 2A, 2B, 2E, 2F, 2G, or 2H is used, relatively strong fixing can be realized.

Further, the SERS units 1G and 1H according to the first embodiment and the SERS units 1N and 1Q according to the second embodiment are in the form in which the second magnet portion is arranged on the side surface side of the SERS element. Therefore, in the SERS units, if the SERS element 2C, 2D, 2E, 2G, or 2H is used, relatively strong fixing can be realized.

However, a combination of the SERS unit and the SERS element described above is merely an example, and the combination of the SERS unit and the SERS element is not limited thereto. That is, if the magnetic force between the first magnet portion and the second magnet portion is adjusted by selecting the material of the first magnet portion or the material of the second magnet portion, all SERS elements can be used for all of the SERS units described above.

### INDUSTRIAL APPLICABILITY

According to an aspect of the present invention, it is possible to provide the surface-enhanced Raman scattering unit capable of suppressing deterioration of the optical functional portion.

### REFERENCE SIGNS LIST

1, 1A, 1B, 1C, 1D, 1E, 1F, 1G, 1H, 1K, 1M, 1N, 1P, 1Q, 1R, 1S, 1T: Surface-enhanced Raman scattering unit (SERS)
2, 2A, 2B, 2C, 2D, 2E, 2F, 2G, 2H, 2S: Surface-enhanced Raman scattering element (SERS element)
3, 3A, 3B, 3C, 3D, 3E, 3F, 3G, 3H, 3K, 3M, 3N, 3P, 3Q, 3R, 3S, 3T: Handling plate (support member)
4, 4S, 4T: First magnet portion
5, 5A, 5C, 5G, 5N, 5Q, 5R, 5S, 5T: Second magnet portion
10: Optical functional portion
21: Substrate
21a: Main surface
21b: Back surface
23: Conductor layer
24: Fine structure portion
31, 71: Main surface (first surface)
32, 72: Back surface (second surface)
33, 37, 44, 46: Recessed portion
33s, 37s, 44s: Bottom surface (first surface)
34s, 36s, 41s, 45s: Bottom surface (second surface)
46a: Inner surface (first surface)
S3a: Inner surface (second surface)
S4a: Inner surface (second surface)

1: A surface-enhanced Raman scattering unit, comprising:
a surface-enhanced Raman scattering element including an optical functional portion causing surface-enhanced Raman scattering; and
a support member supporting the surface-enhanced Raman scattering element,
wherein the surface-enhanced Raman scattering element is fixed to the support member due to a magnetic force.

2: The surface-enhanced Raman scattering unit according to claim 1,
wherein the magnetic force is an attractive force.

3: The surface-enhanced Raman scattering unit according to claim 1,
wherein the surface-enhanced Raman scattering element is arranged in a recessed portion provided in the support member.

4: The surface-enhanced Raman scattering unit according to claim 1, comprising:
a first magnet portion and a second magnet portion generating the magnetic force therebetween,
wherein the first magnet portion is provided in the surface-enhanced Raman scattering element, and
the surface-enhanced Raman scattering element is fixed to the support member by the magnetic force in a state in which the surface-enhanced Raman scattering element is spaced apart from the second magnet portion.

5: The surface-enhanced Raman scattering unit according to claim 4,
wherein the support member includes a first surface and a second surface opposite to the first surface,
the surface-enhanced Raman scattering element is arranged on the first surface,
the second magnet portion is arranged on the second surface, and
the surface-enhanced Raman scattering element is movable along the first surface according to movement of the second magnet portion along the second surface.

6: The surface-enhanced Raman scattering unit according to claim 1, comprising:
a first magnet portion and a second magnet portion generating the magnetic force therebetween,
wherein the first magnet portion is provided in the surface-enhanced Raman scattering element, and
the surface-enhanced Raman scattering element is fixed to the support member by the magnetic force in a state in which the surface-enhanced Raman scattering element is brought into contact with the second magnet portion.

7: The surface-enhanced Raman scattering unit according to claim 1, comprising:
a first magnet portion and a second magnet portion generating the magnetic force therebetween,
wherein the surface-enhanced Raman scattering element is fixed to the support member by the magnetic force in a state in which the surface-enhanced Raman scattering element is sandwiched between the first magnet portion and the second magnet portion.

8: The surface-enhanced Raman scattering unit according to claim 6,
wherein the support member is configured as the second magnet portion.

9: The surface-enhanced Raman scattering unit according to claim 4,
wherein the surface-enhanced Raman scattering element includes a substrate including a main surface and a back surface opposite to the main surface, a fine structure portion provided on the main surface, and a conductor layer provided on the fine structure portion and constituting the optical functional portion, and
the first magnet portion is provided at least one of: on the back surface, between the main surface and the fine structure portion, between the fine structure portion and the conductor layer, and on a side surface of the surface-enhanced Raman scattering element extending in a direction intersecting the main surface.

10: The surface-enhanced Raman scattering unit according to claim 4,
wherein the surface-enhanced Raman scattering element includes a substrate including a main surface and a back surface opposite to the main surface, a fine structure portion provided on the main surface, and a conductor layer provided on the fine structure portion and constituting the optical functional portion, and
at least one of the substrate, the fine structure portion, or the conductor layer is formed as the first magnet portion.
